(19) United States
(12) Patent Application Publication
(10) Pub. No.: US 2026/0071134 A1
(43) Pub. Date: Mar. 12, 2026

(54) CONTROLLED-COMPOSITION CAPPING OF POLYAMINES AND CAPPED POLYAMINES THEREFROM

(71) Applicant: Infineum International Limited, Linden, NJ (US)

(72) Inventors: Nigel Male, Salisbury (GB); Elliot McColl, Abingdon (GB); Gareth Strange, Oxford (GB)

(73) Assignee: Infineum International Limited, Linden, NJ (US)

(21) Appl. No.: 19/323,256

(22) Filed: Sep. 9, 2025

(30) Foreign Application Priority Data
Sep. 12, 2024 (GB) 2413422.3

(51) Int. Cl. C10M 149/22; C08G 81/02

(52) U.S. Cl. CPC C10M 149/22; C08G 81/024; C10M 2217/046

(57) ABSTRACT

A method of capping one or more amine groups within a polymer including providing a polyamine, combining a capping agent with the polyamine at a temperature of less than or equal to 130° C., and recovering capped polyamine, wherein less than 0.01 equivalents of carbon dioxide, based on the equivalents of capping agent used, is released from the reaction. Also disclosed are capped polyamines including one or more polyamines having carbamate capping groups on at least 0.8 equivalents, based on the equivalents of amines in the polyamine, and preferably less than 0.01 equivalents of carbon dioxide, based on the equivalents of capping agent used, released upon formation of the capped polyamine.

### CROSS-REFERENCE TO RELATED APPLICATION

This U.S. Non-provisional application claims priority to Great Britain Patent Application No. 2413422.3 filed on Sep. 12, 2024, the contents of which are herein incorporated by reference in their entirety.

### FIELD

This disclosure relates to the production of capped polyamines and the capped polyamines therefrom, and in particular to chemoselective synthesis of capped polyamines.

### BACKGROUND

Common dispersants used in lubricant formulations include polyamine compounds. Having secondary amines within such structures that can bind or otherwise interact with other components in such lubricant formulations may be undesirable. It is known to use capping agent such as ethylene carbonate to reduce the concentration of secondary amines within organo- or polyamine compounds thus inhibiting undesirable interactions with other compounds. Examples of this reaction, such as described by S. Pirouz, Y. Wang, J. M. Chong, and J. Duhamel, in J. Phys. Chem. B, 119, 12202-12211 (2015), generally only consider a single pathway for the ethylene carbonate to occupy the secondary amines. Yet, it is thought that ethylene carbonate possesses two reactive centres and thus may exhibit two modes of reactivity.

The inventors have identified up to six distinct moieties which can exist when capping polyamines such as polyisobutylene succinic anhydride-co-polyalkylene amine (PIBSA-PAM) with a capping agent such as ethylene carbonate. The inventors have assigned a qualitative distribution of the capping moieties using carbon-13 NMR and monitoring CO₂ (carbon dioxide) released from the reaction. What would be desirable is a method of capping polyamides which favour only one of the reaction pathways giving carbamate single caps and/or subsequent carbonate multiple caps with minimal evolution of carbon dioxide.

### SUMMARY

Disclosed herein is a method of capping one or more amine groups within a polymer comprising (or consisting of, or consisting essentially of) providing a polyamine, combining a capping agent with the polyamine at a temperature of less than or equal to 130° C., and recovering capped polyamine, wherein less than 0.01 equivalents of carbon dioxide, based on the equivalents of capping agent used, is released from the reaction.

In any embodiment of the disclosed method the combining step takes place for at least 12 hours.

In any embodiment of the disclosed method the combining step is at a temperature within a range from 70° C. to 130° C.

In any embodiment of the disclosed method the combining step takes place in a non-polar solvent or no solvent.

In any embodiment of the disclosed method the polyamine is a polyisobutylene-polyamine block copolymer.

In any embodiment of the disclosed method the capping agent is selected from the group consisting of organic anhydrides having the structure O═C(—O—R)₂, organic carbonates having the structure (RC(O))₂O, and combinations thereof, wherein each R groups is independently selected from C₁ to C₁₀ alkyls, or C₆ to C₁₂ aryls, and wherein two R groups may form a fused saturated or unsaturated ring.

In any embodiment of the disclosed method the capping agent is selected from the group consisting of organic carbonates, organic anhydrides, and combinations thereof.

In any embodiment of the disclosed method the organic carbonates are selected from the group consisting of ethylene carbonate, propylene carbonate, butylene carbonate, dimethyl carbonate, derivatives thereof, and combinations thereof.

In any embodiment of the disclosed method the organic anhydrides are selected from the group consisting of acetic anhydride, propionic anhydride, maleic anhydride, phthalic anhydride, benzoic anhydride, derivatives thereof, and combinations thereof.

In any embodiment of the disclosed method the capped polyamine comprises (or consists of, or consists essentially of) carbamate groups.

Also disclosed is a capped polyamine comprising (or consists of, or consists essentially of) a polyamine having capping groups on at least 0.8 equivalents, based on the equivalents of amines in the polyamine, and less than 0.01 equivalents of carbon dioxide, based on the equivalents of capping agent used, released upon formation of the capped polyamine. Described alternatively, in any embodiment is a capped polyamine comprising (or consisting of, or consisting essentially of) a polyamine having carbamate capping groups on at least 0.8 equivalents, based on the equivalents of amines in the polyamine. As described in these embodiments, the capping groups are the chemical moieties that form as a result of the reactive combination of a capping agent and amine group(s) within and/or pendant to the polyamine.

### BRIEF DESCRIPTION OF THE DRAWING

FIG. 1 is a representative chemical drawing of a polyamine having carbamate capping groups, wherein the carbon-13 NMR peak signals are labelled next to selected carbons.

### DETAILED DESCRIPTION

### A. General Definitions

For purposes of this specification and all claims to this invention, the following words and expressions, if and when used, have the meanings ascribed below.

For purposes herein, the new numbering scheme for the Periodic Table of the Elements is used as set out in CHEMICAL AND ENGINEERING NEWS, 63(5), 27 (1985), i.e., Alkali metals are group 1 metals (e.g., Li, Na, K, etc.) and Alkaline earth metals are group 2 metals (e.g., Mg, Ca, Ba, etc.).

The term “about” means approximately, which includes values obtained by rounding. As used herein, the term “about” modifying the quantity of an ingredient, component, or reactant of the invention employed refers to variation in the numerical quantity that can occur, for example, through typical measuring and liquid handling procedures used for making concentrates or lubricating oil compositions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value. All numerical values within the detailed description and the claims herein are modified by “about” or “approximately” the indicated value.

The term “lubricating oil composition”, or “LOC”, refers to a blend of the additives and base oils as described herein, and optionally, other additives that are known in the oil additives art such as described herein.

The terms “base stocks” and “base oils” are often used interchangeably, but as used herein, “base oil” will be used throughout.

Unless otherwise indicated, all percentages reported are mass % on an active ingredient basis, i.e., without regard to carrier or diluent oil, unless otherwise indicated. The term “mass %” means mass percent of a component, based upon the mass of the composition as measured in grams, unless otherwise indicated.

The term “major amount” means more than 50 mass % of a composition, such as more than 60 mass % of a composition, such as more than 70 mass % of a composition, such as from 80 to 99.009 mass % of a composition, such as from 80 to 99.9 from 80 to 99.009 mass % of a composition, of a composition based upon the mass of the composition.

The term “minor amount” means 50 mass % or less of a composition, such as 40 mass % or less of a composition, such as 30 mass % or less of a composition, such as from 20 to 0.001 mass %, such as from 20 to 0.1 mass %, based upon the mass of the composition.

The terms “oil-soluble” and “oil-dispersible”, or cognate terms, used herein do not necessarily indicate that the compounds or additives are soluble, dissolvable, miscible, or are capable of being suspended in the oil in all proportions. These do mean, however, that they are, for example, soluble or stably dispersible in oil to an extent sufficient to exert their intended effect in the environment in which the oil is employed. Moreover, the additional incorporation of other additives may also permit incorporation of higher levels of a particular additive, if desired.

The term “group” as it relates to substitutions of a hydrogen atom on a hydrocarbyl refers to radical moieties that are bound through a chemical bond to the hydrocarbyl.

The term “hydrocarbon” means a compound of hydrogen and carbon atoms. A “heteroatom” is an atom other than carbon or hydrogen. When referred to as “hydrocarbons”, particularly as “refined hydrocarbons”, the hydrocarbons may also contain one or more heteroatoms or heteroatom-containing groups (such as halo, especially chloro and fluoro, amino, alkoxyl, mercapto, alkylmercapto, nitro, nitroso, sulfoxy, etc.) in specified amounts, preferably in an amount of less than 1 mass % of the hydrocarbon. A “hydrocarbyl” is a hydrocarbon radical, that is, it is deficient in one or more hydrogen and/or carbon atoms such that it is a group chemically bound to another compound or group. In any embodiment, the group consists essentially of, such as consists only of, hydrogen and carbon atoms, unless specified otherwise. In an embodiment the hydrocarbyl group comprises an aliphatic hydrocarbyl group. The term “hydrocarbyl” includes “alkyl”, “alkenyl”, “alkynyl”, and “aryl” as defined herein. Hydrocarbyl groups may contain one or more atoms/groups other than carbon and hydrogen provided they do not affect the essentially hydrocarbyl nature of the hydrocarbyl group.

The term “alkyl” means a monovalent group of carbon and hydrogen (such as a C₁ to C₃₀, such as a C₁ to C₁₂ group). Alkyl groups in a compound are typically bonded to the compound directly via a carbon atom. Unless otherwise specified, alkyl groups may be linear (i.e., unbranched) or branched, be cyclic, acyclic, or part cyclic/acyclic. In an embodiment the alkyl group comprises a linear or branched acyclic alkyl group. Representative examples of alkyl groups include, but are not limited to, methyl, ethyl, n-propyl, iso-propyl, n-butyl, sec-butyl, iso-butyl, tert-butyl, n-pentyl, iso-pentyl, neo-pentyl, hexyl, heptyl, octyl, dimethyl hexyl, nonyl, decyl, undecyl, dodecyl, tridecyl, tetradecyl, pentadecyl, hexadecyl, heptadecyl, octadecyl, nonadecyl, icosyl and triacontyl.

The term “alkenyl” means a monovalent group of carbon and hydrogen (such as a C₂ to C₃₀ group, such as a C₂ to C₁₂ group) having at least one double bond. Alkenyl groups in a compound are typically bonded to the compound directly via a carbon atom. Unless otherwise specified, alkenyl groups may be linear (i.e., unbranched) or branched, be cyclic, acyclic or part cyclic/acyclic.

The term “alkylene” means a C₁ to C₂₀, such as a C₁ to C₁₀, bivalent saturated aliphatic group, which may be linear or branched. Representative examples of alkylene include methylene, ethylene, propylene, butylene, pentylene, hexylene, heptylene, octylene, nonylene, decylene, 1-methyl ethylene, 1-ethyl ethylene, 1-ethyl-2-methyl ethylene, 1,1-dimethyl ethylene, and 1-ethyl propylene.

An “olefin”, alternatively referred to as an “alkene”, is a linear, branched, or cyclic compound of carbon and hydrogen having at least one double bond. For purposes of this specification and the claims appended thereto, when a polymer or copolymer is referred to as comprising an olefin (“olefinic”), the olefin present in such polymer or copolymer is the polymerized form of the olefin. For example, when a copolymer is said to have an “isoprene” content of 55 mass % to 95 mass %, it is understood that the “mer” unit in the copolymer is derived from isoprene in the polymerization reaction and said derived units are present at 55 mass % to 95 mass %, based upon the weight of the copolymer. A “polymer” has two or more of the same or different mer units. A “homopolymer” is a polymer having mer units that are the same. A “copolymer” is a polymer having two or more mer units that are different from each other. “Different” as used to refer to mer units indicates that the mer units differ from each other by at least one atom or are different isomerically. An “isoprene polymer” or “isoprene copolymer” is a polymer or copolymer comprising at least 50 mol % isoprene derived units, a “butadiene polymer” or “butadiene copolymer” is a polymer or copolymer comprising at least 50 mol % butadiene derived units, and so on. Likewise, when a polymer is referred to as a “partially or fully saturated polymer comprising C₄₋₅ olefins”, the C₄-s olefin(s) present in such polymer or copolymer are the polymerized form of the olefin(s), and the polymer has been partially or fully saturated (such as by hydrogenation) after polymerization of the monomers.

The term “alkynyl” means a monovalent C₂ to C₃₀ (such as a C₂ to C₁₂) group, which includes at least one carbon-to-carbon triple bond.

The term “aryl” means a group containing at least one aromatic ring, such a cyclopentadiene, phenyl, naphthyl, anthracenyl, and the like. Aryl groups are typically C₅ to C₄₀ (such as C₅ to C₁₈, such as C₆ to C₁₄) aryl groups, optionally substituted by one or more hydrocarbyl groups, heteroatoms, or heteroatom-containing groups (such as halo, hydroxyl, alkoxy and amino groups). Preferred aryl groups include phenyl and naphthyl groups and substituted derivatives thereof, especially phenyl, and alkyl substituted derivatives of phenyl.

The term “substituted” means that a hydrogen atom has been replaced with hydrocarbon group, a heteroatom, or a heteroatom-containing group. An alkyl substituted derivative means a hydrogen atom has been replaced with an alkyl group. An “alkyl substituted phenyl” is a phenyl group where a hydrogen atom has been replaced by an alkyl group, such as a C₁ to C₂₀ alkyl group, such as methyl, ethyl, n-propyl, iso-propyl, n-butyl, sec-butyl, iso-butyl, tert-butyl, n-pentyl, iso-pentyl, neo-pentyl, hexyl, heptyl, octyl, dimethyl hexyl, nonyl, decyl, undecyl, dodecyl, tridecyl, tetradecyl, pentadecyl, hexadecyl, heptadecyl, octadecyl, nonadecyl, icosyl and/or triacontyl.

The term “halogen” or “halo” means a Group 17 atom or a group of Group 17 atom such as chlorine.

The term “effective amount” in respect of an additive means an amount of such an additive in a LOC so that the additive provides the desired technical effect.

The term “ppm” means parts per million by mass, based on the total mass of the composition or LOC, unless otherwise indicated.

The term “metal content” of a LOC or of an additive component, for example, magnesium content, molybdenum content or total metal content (i.e., the sum of all individual metal contents), is measured by ASTM D5185. In particular, phosphorus, boron, calcium, zinc, molybdenum, sodium, silicon, sulfur, and magnesium content are measured by ASTM D5185.

The term “absent” as it relates to components included within the lubricating oil composition s described herein and the claims thereto means that the particular component is present at 0 mass %, based upon the weight of the LOC, or if present in the LOC the component is present at levels that do not impact the LOC properties, such as less than 10 ppm, or less than 1 ppm or less than 0.001 ppm. When the term “absent” is used in relation to monomer reactants and/or to repeat units in (co)polymers described herein, it means present at 0 mass %, based upon the weight of all (co)monomers in the (co)polymer, or, if present at all, at levels so low that they do not substantially impact the physical properties of the (co)polymer, such as at 0.2 mass % or less or at 0.1 mass % or less.

As used herein, Mn is number average molecular weight, Mw is weight average molecular weight, and Mz is z-average molecular weight. Molecular weight distribution (MWD), also referred to as polydispersity index (PDI), is defined to be Mw divided by Mn. Unless otherwise noted, all molecular weight units (e.g., Mw, Mn, Mz) are reported in g/mol and determined by Gel Permeation Chromatography using polystyrene standards.

Total Base Number also referred to as “TBN”, in relation to an additive component or of a LOC (i.e., unused LOC) means total base number as measured by ASTM D2896 and reported in units of mgKOH/g.

Sulfated ash (“SASH”) content is measured by ASTM D874.

Kinematic viscosity (KV100, KV40) is determined pursuant to ASTM D445-19a and reported in units of cSt, unless otherwise specified.

Viscosity index is determined according to ASTM D2270.

Saponification number (SAP) is determined by ASTM D94, and reported in units of mgKOH/g.

Also, it will be understood that various components used, essential as well as optimal and customary, may react under conditions of formulation, storage or use and that the disclosure also provides the product obtainable or obtained as a result of any such reaction.

Also, it will be understood that the preferred features of each aspect of the present disclosure are regarded as preferred features of every other aspect of the present disclosure. Accordingly, preferred and more preferred features of one aspect of the present disclosure may be independently combined with other preferred and/or more preferred features, as well as upper and lower numerical limits of a range, of the same aspect or different aspects of the present disclosure.

### B. Description of the Invention

This disclosure relates to methods of capping one or more amine groups within a polymer such as a polyamine. The invention also relates to capped polyamines which can be produced in one embodiment by the methods described herein. The inventors have unexpectedly found conditions which favour a particular reaction pathway(s) giving carbamate single caps in polyamines and/or subsequent carbonate multiple caps, both with minimal evolution of carbon dioxide. When capping amine containing polymers such as polyamines using the conditions found by the inventors, the same level of —NH capping conversion can be achieved as determined by NMR but with a different distribution of capping moieties as determined by carbon-13 NMR. The carbon-13 NMR integrals can be characterized or “fingerprinted” for the capped polyamines yielded by the inventive methods demonstrating the distinct change in capping moiety distribution.

Thus, in any embodiment is a method of capping one or more amine groups within a polyamine, pendant to a polyamine, or both, comprising providing a polyamine, combining a capping agent with the polyamine at a temperature of less than or equal to 130° C., and recovering capped polyamine, wherein less than 0.01 equivalents of carbon dioxide, based on the equivalents of capping agent used, is released from the reaction. An example of such a method of combining a capping agent with a polyamine is shown in reaction scheme (A):

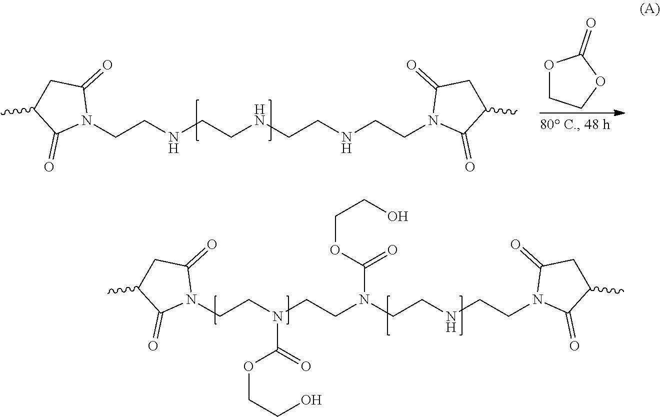

wherein the ethylene carbonate compound is a non-limiting example of a capping agent, combined with the polyamine on the left side of the reaction scheme at 80° C. for 48 hours to produce a capped polyamine shown on the right side of the reaction scheme. In any embodiment, wherein the capped polyamine comprises (or consists of) carbamate groups as shown in the right side of the reaction scheme (A).

In any embodiment, less than 0.001, or less than 0.0001 equivalents of carbon dioxide is released from the reaction. Carbon dioxide can be a product of the combination of the capping agent with the polyamine. In a preferred embodiment, no detectable carbon dioxide is released from the reaction.

In any embodiment, the combining step takes place for at least 12 hours, or for at least 16 hours, or at least 18 hours, or at least 20 hours, or at least 24 hours, or at least 30 hours, or at least 40 hours, or at least 48 hours. In any embodiment, the combining step takes place for less than 120 hours, or less than 100 hours, or less than 80 hours.

In any embodiment, the combining step is at a temperature within a range from 70° C. to 130° C., or within a range from 70° C. to 120° C., or within a range from 80° C. to 120° C., or within a range from 80° C. to 100° C. In any embodiment, the temperature can fluctuate within the desirable range, such as by ±5, or +10, or +15 or more degrees. The temperature specified herein is the average temperature of the reaction medium which can include a diluent or solvent as well as the polyamine and capping agent as measured by any calibrated standard means. The temperature can be controlled by any known means such as by controlled thermal jacketing of the vessel or tube in which the reaction takes place, or heating/cooling the reactants and, if present, diluent entering the reaction vessel or tube.

In any embodiment, the combining step takes place in a non-polar solvent (or diluent) or no solvent (or diluent). The polyamine itself may be in the form of a liquid under the reaction conditions and thus may act as both the reactant and reaction medium. Any other solvent or diluent could include oils such as oils used in lubricating oils for combustion engines.

The polyamine can be any amine-containing polymer having any number of amine groups within the polymer chain, pendant to the polymer chain, or both. In any embodiment the polyamine is a polyisobutylene-polyamine block copolymer. A particularly useful class of polyamine includes (poly)alkenylsuccinic derivatives, typically produced by the reaction of a long chain hydrocarbyl-substituted succinic compound, usually a hydrocarbyl-substituted succinic anhydride, with a polyhydroxy or polyamino compound. The long chain hydrocarbyl group constituting the oleophilic portion of the molecule which confers solubility in the oil, is often a polyisobutylene group (typically the long chain hydrocarbyl group, such as a polyisobutylene group, has an Mn of 400 to 3000 g/mol, such as 450 to 2500 g/mol). Many examples of this type of polyamine are used as dispersants in lubricating oil compositions and are well known commercially and in the literature. They are described further herein.

A particularly useful type of polyamine useful herein are formed by the condensation reaction between 1) hydrocarbyl-substituted succinic anhydrides, such as polyisobutylene succinic anhydride (PIBSA); and 2) polyamine (PAM). Examples of suitable polyamines include: polyhydrocarbyl polyamines, polyalkylene polyamines, hydroxy-substituted polyamines, polyoxyalkylene polyamines, and combinations thereof. Examples of polyamines include tetraethylene pentamine, pentaethylene hexamine, tetraethylenepentamine (TEPA), pentaethylenehaxamine (PEHA), N-phenyl-p-phenylenediamine (ADPA), and other polyamines having an average of 5, 6, 7, 8, or 9 nitrogen atoms per molecule. These are also described further herein.

In any embodiment, the capping agent is selected from the group consisting of organic anhydrides having the structure O═C(—O—R)₂, organic carbonates having the structure (RC(O))₂O, and combinations thereof, wherein each R groups is independently selected from C₁ to C₁₀ alkyls, or C₆ to C₁₂ aryls, and wherein two R groups may form a fused saturated or unsaturated ring.

More particularly, in any embodiment the capping agent is selected from the group consisting of organic carbonates, organic anhydrides, and combinations thereof. In any embodiment the organic carbonates are selected from the group consisting of ethylene carbonate, propylene carbonate, butylene carbonate, dimethyl carbonate, derivatives thereof, and combinations thereof. In any embodiment the organic anhydrides are selected from the group consisting of acetic anhydride, propionic anhydride, maleic anhydride, phthalic anhydride, benzoic anhydride, derivatives thereof, and combinations thereof.

The capping agent may be combined in any desirable quantitative amount relative to the polyamine with which it is combined, such as within a range from 3 equivalents to 0.5 equivalents per equivalent of amine in the polyamine, or within a range from 2 equivalents to 0.8 equivalents per equivalent of amine in the polyamine, or within a range from 1.5 to 1 equivalents per equivalent of amine in the polyamine.

Also disclosed in any embodiment is a capped polyamine. In any embodiment, a capped polyamine is disclosed comprising a polyamine having capping groups on at least 0.8 equivalents, based on the equivalents of amines in the polyamine; and less than 0.01 equivalents of carbon dioxide, based on the equivalents of capping agent used, released upon formation of the capped polyamine. In a preferred embodiment the capped polyamine is made by the methods described herein.

In another embodiment is a capped polyamine comprising a polyamine having carbamate capping groups on at least 0.8 equivalents, based on the equivalents of amines in the polyamine; and, in one embodiment, less than 0.01 or 0.001 equivalents of carbon dioxide, based on the equivalents of capping agent used, released upon formation of the capped polyamine. In a preferred embodiment this capped polyamine is made by the methods described herein.

In any embodiment the polyamine comprises capping groups on at least 0.8 equivalents of the amines in the polyamine based on the equivalents of amines in the polyamine, or at least 0.85 equivalents, or at least 0.9 equivalents, or at least 0.95 equivalents, or at least 0.99 equivalents, based on the equivalents of amines in the polyamine. As used herein, “in the polyamine” means amines that are either part of the polymer chain, pendant to the polymer, or both. Also, as used herein, when stating “comprising a polyamine having capping groups on at least 0.8 equivalents” it is understood that there are the stated equivalents of capping agents that have reacted with the amines to form capping groups that are part of the polymer chain, pendant to the polymer chain, or both, such as “on at least 0.8 equivalents of the amines in the polyamine based on the equivalents of amines in the polyamine.” A “capping group” is the chemical moiety that has replaced the hydrogen atom of the amine with a moiety such as a carbamate, an ethanolamine, or some other by-product of the reaction between a capping agent and one or more amines in the polyamine.

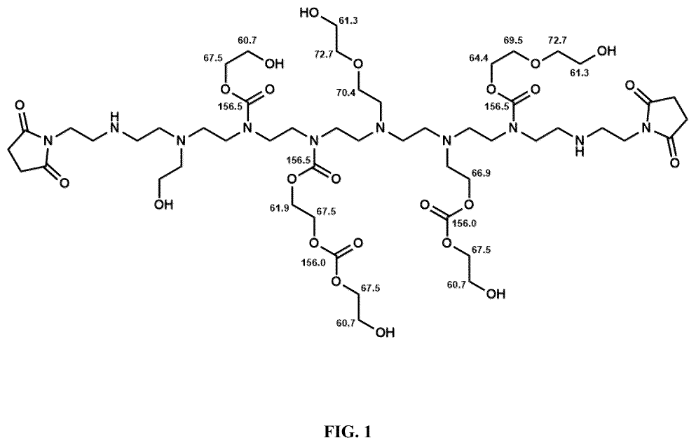

In any embodiment, the capping groups of the capped polyamine comprise (or consist of, or consist essentially of) carbamate groups. Exemplary capped polyamines are shown in the right-hand side of the reaction scheme (A), and in FIG. 1.

In any embodiment of the capped polyamine, less than 0.001 equivalents of carbon dioxide is released. In a preferred embodiment, no detectable carbon dioxide is released.

In any embodiment of the capped polyamine, the polyamine is a polyisobutylene-polyamine block copolymer.

In any embodiment of the capped polyamine, the capping group is selected from the group consisting of the reaction products of the polyamine with organic anhydrides having the structure O═C(—O—R)₂, organic carbonates having the structure (RC(O))₂O, and combinations thereof, wherein each R groups is independently selected from C₁ to C₁₀ alkyls, C₆ to C₁₂ aryls, and wherein two R groups may form a fused saturated or unsaturated ring.

In any embodiment of the capped polyamine, the capping group is selected from the group consisting of the reaction product of the polyamine with organic carbonates, organic anhydrides, and combinations thereof. In any embodiment of the capped polyamine, the organic carbonates are selected from the group consisting of ethylene carbonate, propylene carbonate, butylene carbonate, dimethyl carbonate, derivatives thereof, and combinations thereof. In any embodiment of the capped polyamine, the organic anhydrides are selected from the group consisting of acetic anhydride, propionic anhydride, maleic anhydride, phthalic anhydride, benzoic anhydride, derivatives thereof, and combinations thereof. In a preferred embodiment the capping group is a carbamate, most preferably groups selected from the group consisting of structures P—N—C(O)—O—R, wherein the nitrogen is either within the polymer chain P or pendant to the polymer chain P, and wherein R is an alkyl, alkoxy, aryl group, or substituted versions thereof.

Also disclosed herein is a lubricant additive package comprising at least one capped polyamine such as described herein. Also disclosed herein is a lubricant oil composition comprising at least one capped polyamine as disclosed herein. The capped polyamine can be used as a dispersant in the LOC, and there may be two or more dispersants in the LOC, wherein at least one is a capped polyamine, but there may be other dispersants that are not capped as described herein, or may be capped by other means.

The various components of the LOC's and their concentrations in the LOC's are described further herein.

### C. Base Oil

The base oil useful herein may be a single oil or a blend of oils and is typically a large liquid constituent of a lubricating oil composition, also referred to as a base oil or lubricant, into which additives and optional additional oils are blended, for example, to produce a LOC, such as a final LOC, a concentrate, or other lubricating composition.

A base oil may be selected from vegetable, animal, mineral, and synthetic lubricating oils, and mixtures thereof. It may range in viscosity from light distillate mineral oils to heavy lubricating oils, such as those for gas engine oil, mineral lubricating oil, motor vehicle oil, and heavy-duty diesel oil. Generally, the kinematic viscosity at 100° C. (“KV100”) of the base oil ranges from 1 to 30, such as 2 to 25 cSt, such as 5 to 20 cSt, as determined according to ASTM D445-19a, or more particularly from 1.0 cSt to 10 cSt, from 1.5 cSt to 3.3 cSt, from 2.7 cSt to 8.1 cSt, from 3.0 cSt to 7.2 cSt, or from 2.5 cSt to 6.5 cSt. Generally, the high temperature high shear (HTHS) viscosity at 150° C. of the base oil ranges from 0.5 to 20 cP such as 1 to 10 cP, such as 2 to 5 cP as determined according to ASTM D4683-20.

Common oils useful as base oils include animal and vegetable oils (e.g., castor and lard oil), liquid petroleum oils, and hydrorefined and/or solvent-treated mineral lubricating oils of the paraffinic, naphthenic, and mixed paraffinic-naphthenic types. Oils derived from coal or shale are also useful base oils. Base oils may be manufactured using a variety of different processes including, but not limited to, distillation, solvent refining, hydrogen processing, oligomerization, esterification, and re-refining.

Synthetic lubricating oils useful herein as base oils include hydrocarbon oils such as homopolymerized and copolymerized olefins, referred to as polyalphaolefins or PAO's or Group IV base oils [according to the API EOLCS 1509 definition (American Petroleum Institute Publication 1509, § E.1.3, 19th edition, January 2021, www.API.org)]. Examples of PAO's useful as base oils include: poly(ethylenes), copolymers of ethylene and propylene, polybutylenes, polypropylenes, propylene-isobutylene copolymers, chlorinated polybutylenes, poly(1-hexenes), poly(1-octenes), poly(1-decenes), homo- or co-polymers of C₈ to C₂₀ alkenes, homo- or co-polymers of C₈, and/or C₁₀, and/or C₁₂ alkenes, C₈/C₁₀ copolymers, C₈/C₁₀/C₁₂ copolymers, and C₁₀/C₁₂ copolymers, and the derivatives, analogues and homologues thereof.

In another embodiment, the base oil may comprise polyalphaolefins comprising oligomers of linear olefins having 6 to 14 carbon atoms, such as 8 to 12 carbon atoms, such as 10 carbon atoms having a Kinematic viscosity at 100° C. of 10 or more (as measured by ASTM D445); and having a viscosity index (“VI”), as determined by ASTM D2270, of 100 or more, such as 110 or more, such as 120 or more, such as 130 or more, such as 140 or more; and/or having a pour point of −5° C. or less (as determined by ASTM D97), such as −10° C. or less, such as −20° C. or less.

In another embodiment, polyalphaolefin oligomers useful in the present disclosure may comprise C₂₀ to C₁₅₀₀ paraffins, such as C₄₀ to C₁₀₀₀ paraffins, such as C₅₀ to C₇₅₀ paraffins, such as C₅₀ to C₅₀₀ paraffins. The PAO oligomers are dimers, trimers, tetramers, pentamers, etc., of C₅ to C₁₄ alpha-olefins in one embodiment, and C₆ to C₁₂ alpha-olefins in another embodiment, and C₈ to C₁₂ alpha-olefins in another embodiment. Suitable olefins include 1-pentene, 1-hexene, 1-heptene, 1-octene, 1-nonene, 1-decene, 1-undecene, and 1-dodecene. In one embodiment, the olefin is a combination of 1-octene, 1-decene, and 1-dodecene, or such as may be substantially 1-decene, and the PAO is a mixture of dimers, trimers, tetramers, and pentamers (and higher) thereof. Useful PAO's are described more particularly in, for example, U.S. Pat. Nos. 5,171,908 and 5,783,531, and in Synthetic Lubricants and High-Performance Functional Fluids, 1-52 (Leslie R. Rudnick & Ronald L. Shubkin, ed. Marcel Dekker, Inc., 1999).

Polyalphaolefins useful in the present disclosure typically possess a number average molecular weight of from 100 to 21,000 g/mol in one embodiment, such as from 200 to 10,000 g/mol in another embodiment, such as from 200 to 7,000 g/mol in yet another embodiment, such as from 200 to 2,000 g/mol in yet another embodiment, and such as from 200 to 500 g/mol in yet another embodiment. Desirable PAO's are commercially available as SpectraSyn™ Hi-Vis, SpectraSyn™ Low-Vis, SpectraSyn™ plus, SpectraSyn™ Elite PAO's (ExxonMobil Chemical Company, Houston Texas) and Durasyn™ PAO's from Ineos Oligomers USA LLC.

Synthetic lubricating oils useful as base oils also include hydrocarbon oils such as homopolymerized and copolymerized: alkylbenzenes (e.g., dodecylbenzenes, tetradecylbenzenes, dinonylbenzenes, di(2-ethylhexyl) benzenes); polyphenols (e.g., biphenyls, terphenyls, alkylated polyphenols); and alkylated diphenyl ethers, and alkylated diphenyl sulfides; and the derivatives, analogues, and homologues thereof.

Another suitable class of synthetic lubricating oils useful as base oils comprises the esters of dicarboxylic acids (e.g., phthalic acid, succinic acid, alkyl succinic acids and alkenyl succinic acids, maleic acid, azelaic acid, suberic acid, sebasic acid, fumaric acid, adipic acid, linoleic acid dimer, malonic acid, alkylmalonic acids, alkenyl malonic acids) reacted with a variety of alcohols (e.g., butyl alcohol, hexyl alcohol, dodecyl alcohol, 2-ethylhexyl alcohol, ethylene glycol, diethylene glycol monoether, propylene glycol). Specific examples of these esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, and the complex ester formed by reacting one mole of sebacic acid with two moles of tetraethylene glycol and two moles of 2-ethylhexanoic acid.

Esters useful as synthetic oils herein also include those made from C₅ to C₁₂ monocarboxylic acids and polyols, and polyol ethers such as neopentyl glycol, trimethylolpropane, pentaerythritol, dipentaerythritol, and tripentaerythritol.

Desirable ester base oils are commercially available as Esterex™ Esters (ExxonMobil Chemical Company).

Silicon-based oils such as the polyalkyl-, polyaryl-, polyalkoxy- or polyaryloxysilicone oils and silicate oils comprise another useful class of synthetic lubricants useful herein; such oils include tetraethyl silicate, tetraisopropyl silicate, tetra-(2-ethylhexyl) silicate, tetra-(4-methyl-2-ethylhexyl)silicate, tetra-(p-tert-butyl-phenyl) silicate, hexa-(4-methyl-2-ethylhexyl)disiloxane, poly(methyl)siloxanes, and poly(methylphenyl)-siloxanes.

Other synthetic lubricating oils useful herein include liquid esters of phosphorous-containing acids (e.g., tricresyl phosphate, trioctyl phosphate, diethyl ester of decylphosphonic acid) and polymeric tetrahydrofurans.

Unrefined, refined, and re-refined oils can be used in the LOC of the present disclosure. Unrefined oils are those obtained directly from a natural or synthetic source without further purification treatment. For example, shale oil obtained directly from retorting operations, a petroleum oil obtained directly from distillation, or an ester oil obtained directly from an esterification process and used without further treatment is considered an unrefined oil. Refined oils are similar to unrefined oils except they have been further treated in one or more purification steps to improve one or more properties. Many such purification techniques, such as distillation, solvent extraction, acid or base extraction, filtration, and percolation are used by those in the art. Re-refined oils are oils obtained by processes similar to those used to obtain refined oils where the refining processes are applied to previously refined oils which have been previously used in service. Such re-refined oils are also referred to as reclaimed or reprocessed oils and often are additionally processed for removal of spent additive and oil breakdown products. Such re-refined oils are absent from the LOCs in an embodiment.

Other examples of useful base oils are gas-to-liquid (“GTL”) base oils, i.e., the base oil is an oil derived from hydrocarbons made from synthesis gas (“syn gas”) containing H₂ and CO using a Fischer-Tropsch catalyst. These hydrocarbons typically require further processing in order to be useful as a base oil. For example, they may, by methods known in the art, be hydroisomerized; hydrocracked and hydroisomerized; dewaxed; or hydroisomerized and dewaxed.

In any embodiment, oils from renewable sources, i.e., based in part on carbon and energy captured from the environment, such as biological sources, are useful herein.

The various base oils are often categorized as Group I, II, III, IV, or V according to the API EOLCS 1509 definition (American Petroleum Institute Publication 1509, see section E.1.3, 19th edition, January 2021, www.API.org). In an embodiment the Group I base oils have a viscosity index of between 80 to 120 and contain greater than 0.03% sulfur and/or less than 90% saturates. Group II base oils have a viscosity index of between 80 to 120 and contain less than or equal to 0.03% sulfur and greater than or equal to 90% saturates. Group III base oils have a viscosity index greater than 120 and contain less than or equal to 0.03% sulfur and greater than 90% saturates. Group IV base oils includes PAO's. Group V base oils include base oils not included in Groups I-IV. (Viscosity index measured by ASTM D 2270, saturates is measured by ASTM D2007, and sulfur is measured by ASTM D5185, D2622, ASTM D4294, ASTM D4927, and ASTM D3120).

Base oils for use in the formulated LOC useful in the present disclosure are any one, two, three, or more of the variety of oils described herein. In desirable embodiments, base oils for use in the formulated LOC useful in the present disclosure are those described as API Group I, Group II, Group III (including Group III+), Group IV, and Group V oils and mixtures thereof, such as API Group II, Group III, Group IV, and Group V oils and mixtures thereof, such as the Group III, Group III+, IV, and Group V base oils due to their exceptional volatility, stability, viscometric, and cleanliness features. Minor quantities of Group I base oil, such as the amount used to dilute additives for blending into formulated lube oil products, can be tolerated but are typically kept to a minimum, e.g., amounts only associated with their use as diluent/carrier oil for additives used on an “as-received” basis. In regard to the Group II stocks, it is more useful that the Group II base oil be in the higher quality range associated with that stock, i.e., a Group II stock having a viscosity index in the range from 100 to 120.

The base oil useful herein may be selected from any of the synthetic, natural, or re-refined oils (such as those typically used as crankcase lubricating oils for spark-ignited and compression-ignited engines). Mixtures of synthetic and/or natural and/or re-refined base oils may be used if desired. Multi-modal mixtures (such as bi- or tri-modal mixtures) of Group I, II, III, IV, and/or V base oils may be used if desired.

The base oil or base oil blend used herein conveniently has a kinematic viscosity at 100° C. (KV100, as measured according to ASTM D445-19a, and reported in units of centistoke (cSt) or it its equivalent, mm²/s), of 2 to 40 cSt, such as of 3 to 30 cSt, such as 4 to 20 cSt at 100° C., such as 5 to 10 cSt, such as the base oil or base oil blend may have a kinematic viscosity at 100° C. of 2 to 20 cSt, of 2.5 to 2 cSt, and such as of 2.5 cSt to 9 cSt.

In an embodiment the base oil or base oil blend has a saturate content of at least 65 mass %, such as at least 75 mass %, such as at least 85 mass %, such as at least 90 mass % as determined by ASTM D2007.

In an embodiment the base oil or base oil blend will have a sulfur content of less than 1 mass %, such as less than 0.6 mass %, such as less than 0.4 mass %, such as less than 0.3 mass %, based on the total mass of the lubricating composition, as measured by ASTM D5185.

In any embodiment, the viscosity index (VI) of the base oil is at least 95, such as at least 110, such as at least 120, even such as at least 125, such as from 130 to 240, such as from 105 to 140 (as determined by ASTM D2270).

The base oil may be provided in a major amount, or in combination with a minor amount of one or more additive components as described herein. This preparation may be accomplished by adding the additives directly to the oil or by adding one or more additives in the form of a concentrate thereof to disperse or dissolve the additive(s). Additives may be added to the oil by any method known to those skilled in the art, either before, at the same time as, or after addition of other additives.

The base oil may be provided in a minor amount, in combination with minor amounts of one or more additive components as described hereinafter, constituting an additive concentrate. This preparation may be accomplished by adding the additives directly to the oil or by adding one or more additives in the form of a solution, slurry or suspension thereof to disperse or dissolve the additive(s) in the oil. Additives may be added to the oil by any method known to those skilled in the art, either before, at the same time as, or after addition of other additives.

The base oil typically constitutes the major component of an engine oil LOC of the present disclosure and typically is present in an amount within a range from 60 to 95 mass %, or within a range from 70 to 90 mass %, and such as from 75 to 90 mass %, based on the total weight of the composition.

The base oils and blends thereof described above are also useful for making concentrates as well as for making lubricants therefrom. Concentrates constitute a convenient means of handling additives before their use, as well as facilitating solution or dispersion of additives in lubricants. When preparing a lubricant that contains more than one type of additive (sometime referred to as “additive components”), each additive may be incorporated separately, each in the form of a concentrate. In many instances, however, it is convenient to provide a so-called additive “package” (or “addpack”) comprising one or more additives/co-additives, such as described hereinafter, in a single concentrate.

In any embodiment, one or more base oils are present in the concentrate composition in an amount of 50 mass % or less, such as 40 mass % or less, such as 30 mass % or less, such as 20 mass % or less, based on the total weight of the concentrate composition. In any embodiment the one or more base oils are present in the concentrate composition within a range from 5 to 50 mass %, such as 5 to 40 mass %, such as to 10 to 30 mass %, based upon the weight of the concentrate composition.

The lubricating oil compositions and concentrates according to the present disclosure may further comprise one or more additives such as detergents, friction modifiers, antioxidants, pour point depressants, anti-foam agents, viscosity modifiers, dispersants, corrosion inhibitors, antiwear agents, extreme pressure additives, demulsifiers, seal compatibility agents, additive diluent base oils, etc. Specific examples of such additives are described in, for example, Kirk-Othmer Encyclopedia of Chemical Technology, 3^{rd} ed., 14, 477-526 (1978), and several are discussed in further detail below. In any embodiment the LOC's comprise within a range from 5 to 40 mass % of the additives, or within a range from 10 to 30 mass %, or within a range from 10 to 25 mass %, based on the weight of the LOC. In the concentrates described herein, additives may comprise within a range from 50 to 95 mass %, or within a range from 60 to 95 mass % of the concentrate, or within a range from 70 to 90 mass %, based on the weight of the concentrate.

Various types of additives such as polyamines which can be used as dispersants are discussed further below.

### D. Organic Friction Modifiers

The LOC and concentrates described herein comprise one or more organic friction modifiers. An organic friction modifier is any material or materials that can alter the coefficient of friction of a surface lubricated by any lubricant or fluid-containing such material(s). Organic friction modifiers may be present in the lubricating oil compositions of the present disclosure and are known generally and include esters formed by reacting carboxylic acids and anhydrides with alkanols and amine-based friction modifiers. Other useful friction modifiers generally include a polar terminal group (e.g., carboxyl or hydroxyl) covalently bonded to an oleophilic hydrocarbon chain. Esters of carboxylic acids and anhydrides with alkanols are described in U.S. Pat. No. 4,702,850. Examples of other conventional organic friction modifiers are described by M. Belzer in the “Journal of Tribology” Vol. 114, pp. 675-682 (1992), and M. Belzer and S. Jahanmir in “Lubrication Science” Vol. 1, pp. 3-26 (1988). Typically, the total amount of organic friction modifier in a lubricant according to the present disclosure does not exceed 5 mass %, based on the total mass of the lubricating oil composition and preferably does not exceed 2 mass % and more preferably does not exceed 0.5 mass %.

Illustrative friction modifiers useful in the lubricating compositions described herein include, for example, alkoxylated fatty acid esters, alkanolamides, polyol fatty acid esters, borated glycerol fatty acid esters, fatty alcohol ethers, and combinations thereof.

Illustrative alkoxylated fatty acid esters include, for example, polyoxyethylene stearate, fatty acid polyglycol ester, and the like. These can include polyoxypropylene stearate, polyoxybutylene stearate, polyoxyethylene isosterate, polyoxypropylene isostearate, polyoxyethylene palmitate, and the like.

Illustrative alkanolamides include, for example, lauric acid diethylalkanolamide, palmic acid diethylalkanolamide, and the like. These can include oleic acid diethyalkanolamide, stearic acid diethylalkanolamide, oleic acid diethylalkanolamide, polyethoxylated hydrocarbylamides, polypropoxylated hydrocarbylamides, and the like.

Illustrative polyol fatty acid esters include, for example, glycerol monooleate, saturated mono-, di-, and tri-glyceride esters, glycerol monostearate, and the like. These can include polyol esters, hydroxyl-containing polyol esters, and the like.

Illustrative borated glycerol fatty acid esters include, for example, borated glycerol monooleate, borated saturated mono-, di-, and tri-glyceride esters, borated glycerol monostearate, and the like. In addition to glycerol polyols, these can include trimethylolpropane, pentaerythritol, sorbitan, and the like. These esters can be polyol monocarboxylate esters, polyol dicarboxylate esters, and on occasion polyoltricarboxylate esters. Preferred can be the glycerol monooleates, glycerol di-oleates, glycerol tri-oleates, glycerol mono-oleates, glycerol di-stearates, and glycerol tri-stearates and the corresponding glycerol mono-palmitates, glycerol di-palmitates, and glycerol tri-palmitates, and the respective isostearates, linoleates, and the like. Ethoxylated, propoxylated, and/or butoxylated fatty acid esters of polyols, especially using glycerol as underlying polyol are useful herein.

Illustrative fatty alcohol ethers include, for example, stearyl ether, myristyl ether, and the like. Alcohols, including those that have 3 to 50 carbon atoms, can be ethoxylated, propoxylated, or butoxylated to form the corresponding fatty alkyl ethers. The underlying alcohol portion can preferably be stearyl, myristyl, C₁₁-C₁₃ hydrocarbons, oleyl, isosteryl, and the like.

In any embodiment the organic friction modifier is selected from the group consisting of C₁₀ to C₃₀ 1-monoglycerides, C₁₀ to C₃₀ 2-monoglycerides, C₁₀ to C₃₀ alkyl amine fatty acid salts, alkyl branched derivatives thereof, and combinations thereof.

In any embodiment the organic friction modifiers are present in the LOC within a range from 0.1 mass % to 5 mass %, or 0.15 mass % to 4 mass %, or 0.2 mass % to 3 mass %, or 0.4 mass % to 2 mass %, based on the total weight of the LOC.

In any embodiment the organic friction modifiers are present in the concentrate within a range from 1 mass % to 30 mass %, or 2 mass % to 25 mass %, or 3 mass % to 20 mass %, based on the total weight of the concentrate.

### E. Inorganic Friction Modifier

The LOC and concentrates described herein comprise one or more inorganic friction modifiers. Illustrative inorganic friction modifiers may include, for example, organometallic compounds or materials, or combinations thereof. Illustrative organometallic friction modifiers useful in the lubricating oil formulations of this disclosure include, for example, tungsten and/or molybdenum compounds, such as molybdenum amine, molybdenum diamine, an organotungstenate, a molybdenum dithiocarbamate, molybdenum dithiophosphates, molybdenum amine complexes, molybdenum carboxylates, and the like, and combinations thereof. In any embodiment the inorganic friction modifier is selected from the group consisting of tungsten and molybdenum amines, diamines, dithiocarbamates, dithiophosphates, carboxylates, organomolybdenates and organotungstenates, and the like, and combinations thereof. Molybdenum-based friction modifiers are particularly preferred. Examples of useful molybdenum-based compounds may conveniently include molybdenum dithiocarbamates, trinuclear molybdenum compounds, for example, as described in PCT Publication No. WO 98/26030, sulfides of molybdenum and molybdenum dithiophosphate.

Other known friction modifiers comprise oil-soluble organo-molybdenum compounds. Such organo-molybdenum friction modifiers may also provide antioxidant and anti-wear credits to a lubricating oil composition. Examples of such oil-soluble organo-molybdenum compounds include dithiocarbamates, dithiophosphates, dithiophosphinates, xanthates, thioxanthates, sulfides, and the like, and combinations thereof. Particularly preferred are molybdenum dithiocarbamates, dialkyl dithiophosphates, alkyl xanthates and alkyl thioxanthates.

Additionally, the molybdenum compound may be an acidic molybdenum compound. These compounds will react with a basic nitrogen compound as measured by ASTM test D664 or D2896 titration procedure and are typically hexavalent. Included are molybdic acid, ammonium molybdate, sodium molybdate, potassium molybdate, and other alkali metal molybdates and other molybdenum salts, e.g., hydrogen sodium molybdate, MoOC₁₄, MoO₂Br₂, Mo₂O₃C₁₆, molybdenum trioxide or similar acidic molybdenum compounds.

Among the molybdenum compounds useful in the compositions of this disclosure are organo-molybdenum compounds of the formula Mo(ROCS₂)₄ and Mo(RSCS₂)₄, wherein R is selected from the group consisting of C₁ or C₂ to C₁₂ or C₃₀ alkyl, aryl, aralkyl and alkoxyalkyl, groups. Especially preferred are the dialkyl dithiocarbamates of molybdenum.

Another group of organo-molybdenum compounds useful in the lubricating compositions of this disclosure are trinuclear molybdenum compounds, especially those of the formula Mo₃SₖLₙX_{z} and combinations thereof wherein the L are independently selected ligands having organo groups with a sufficient number of carbon atoms to render the compound soluble or dispersible in the oil, n is from 1 to 4, k varies from 4 to 7, X is selected from the group of neutral electron-donating compounds such as water, amines, alcohols, phosphines, and ethers, and z ranges from 0 to 5 and includes non-stoichiometric values. Preferably, at least 21 carbon atoms should be present among all the ligand and organo groups, such as at least 25, at least 30, or at least 35 carbon atoms.

In any embodiment, the inorganic friction modifier is selected from the group consisting of tungsten and molybdenum amines, diamines, dithiocarbamates, dithiophosphates, carboxylates, organomolybdenates and organotungstenates, and the like, and combinations thereof.

In any embodiment the molybdenum friction modifier is selected from molybdenum dialkyl dithiocarbamate compounds and combinations thereof, wherein the alkyl groups are, independently, selected from C₃ to C₂₀ alkyl groups and C₆ to C₁₀ aryl groups.

Concentrations of molybdenum-containing materials are often described in terms of molybdenum metal concentration. In any embodiment the inorganic friction modifier, and preferably any molybdenum compound, is present in the LOC within a range from 0.01 mass % to 2 mass %, or within the preferred range from 0.05 mass % to 1 mass %, or within a range from 0.08 to 0.8 mass %, based on the total weight of the LOC.

In any embodiment the inorganic friction modifier, and preferably any molybdenum compound, is present in the concentrate within a range from 1 mass % to 20 mass %, or within the preferred range from 5 mass % to 15 mass % based on the total weight of the concentrate.

Friction modifiers of all types may be used alone or in mixtures with the materials of this disclosure. Often mixtures of two or more friction modifiers, or mixtures of friction modifier(s) with alternate surface-active material(s), are also desirable. For example, combinations of Mo-containing compounds with polyol fatty acid esters, such as glycerol mono-oleate are useful herein.

### F. Detergents

The LOC and concentrates described herein may include one or more detergents or metal detergents (such as blends of metal detergents) also referred to as a “detergent additive.” Metal detergents typically function both as detergents to reduce or remove deposits and as acid neutralizers or rust inhibitors, thereby reducing wear and corrosion and extending engine life. Detergents generally comprise a polar head with a long hydrophobic tail, with the polar head comprising a metal salt of an acidic organic compound. The salts may contain a substantially stoichiometric amount of the metal in which case they are usually described as normal or neutral salts, and would typically have a total base number (“TBN” as measured by ASTM D2896) of up to 150 mgKOH/g, such as from 0 to 80 (or 5-30) mgKOH/g. A large amount of a metal base may be incorporated by reacting excess metal compound (e.g., an oxide or hydroxide) with an acidic gas (e.g., carbon dioxide). Such detergents, sometimes referred to as overbased, may have a TBN of 100 mgKOH/g or more (such as 200 mgKOH/g or more), and typically will have a TBN of 250 mgKOH/g or more, such as 300 mgKOH/g or more, such as from 200 to 800 mgKOH/g, 225 to 700 mgKOH/g, 250 to 650 mgKOH/g, or 300 to 600 mgKOH/g, such as 150 to 650 mgKOH/g.

Suitable detergents include, oil-soluble neutral and overbased sulfonates, phenates, sulfurized phenates, thiophosphonates, salicylates, naphthenates and other oil-soluble carboxylates of a metal, particularly the alkali metals (Group 1 metals, e.g., Li, Na, K, Rb) or alkaline earth metals (Group 2 metals, e.g., Be, Mg, Ca, Sr, Ba), particularly, sodium, potassium, lithium, calcium, and magnesium, preferably calcium and magnesium. Furthermore, the detergent may comprise a hybrid detergent comprising any combination of sodium, potassium, lithium, calcium, or magnesium salts of sulfonates, phenates, sulfurized phenates, thiophosphonates, salicylates, and naphthenates or other oil-soluble carboxylates of a Group 1 and/or 2 metal.

Preferably, the detergent additive(s) useful in the present disclosure comprises calcium and/or magnesium metal salts. The detergent may be a calcium and/or magnesium carboxylate (e.g., salicylates), sulfonate, or phenate detergent. More preferably, the detergent additives are selected from magnesium salicylate, calcium salicylate, magnesium sulfonate, calcium sulfonate, magnesium phenate, calcium phenate, and hybrid detergents comprising two, three, four, or more of more of these detergents and/or combinations thereof.

The metal-containing detergent may also include “hybrid” detergents formed with mixed surfactant systems including phenate and/or sulfonate components, e.g., phenate/salicylates, sulfonate/phenates, sulfonate/salicylates, sulfonates/phenates/salicylates, as described, for example, in U.S. Pat. Nos. 6,429,178; 6,429,179; 6,153,565; and 6,281,179. Where, for example, a hybrid sulfonate/phenate detergent is employed, the hybrid detergent would be considered equivalent to amounts of distinct phenate and sulfonate detergents introducing like amounts of phenate and sulfonate soaps, respectively.

The overbased metal-containing detergent may be sodium salts, calcium salts, magnesium salts, or mixtures thereof of the phenates, sulfur-containing phenates, sulfonates, salixarates, and salicylates. Overbased phenates and salicylates typically have a total base number of 180 to 650 mgKOH/g, such as 200 to 450 TBN mgKOH/g. Overbased sulfonates typically have a total base number of 250 to 600 mgKOH/g, or 300 to 500 mgKOH/g. In embodiments, the sulfonate detergent may be predominantly a linear alkylbenzene sulfonate detergent having a metal ratio of at least 8 as is described in paragraphs [0026] to [0037] of US Patent Application Publication No. 2005/065045 (and granted as U.S. Pat. No. 7,407,919). The overbased detergent may be present at 0 mass % to 15 mass %, or 0.1 mass % to 10 mass %, or 0.2 mass % to 8 mass %, or 0.2 mass % to 3 mass %, based upon of the lubricating composition. For example, in a heavy-duty diesel engine, the detergent may be present at 2 mass % to 3 mass % of the lubricating composition. For a passenger car engine, the detergent may be present at 0.2 mass % to 1 mass % of the lubricating composition.

The detergent additive(s) may comprise one or more magnesium sulfonate detergents. The magnesium detergent may be a neutral salt or an overbased salt. Suitably the magnesium detergent is an overbased magnesium sulfonate having a TBN of from 80 to 650 mgKOH/g (ASTM D2896), such as 200 to 500 mgKOH/g, such as 240 to 450 mgKOH/g.

Alternately, the detergent additive(s) is a magnesium salicylate, optionally having a TBN of from 30 to 650 mgKOH/g (ASTM D2896), such as 50 to 500 mgKOH/g, such as 200 to 500 mgKOH/g, such as 240 to 450 mgKOH/g or alternately of 150 mgKOH/g or less, such as 100 mgKOH/g or less.

The magnesium detergent typically provides the lubricating composition thereof with from 200-4000 ppm of magnesium atoms, suitably from 200-2000 ppm, from 300 to 1500 or from 450-1200 ppm of magnesium atoms (ASTM D5185).

The detergent composition may comprise (or consist of) a combination of one or more magnesium sulfonate detergents and one or more calcium salicylate detergents. Alternately, the detergent additive(s) is a combination of magnesium salicylate and magnesium sulfonate.

The combination of one or more magnesium sulfonate detergents and one or more calcium salicylate detergents optionally provides the lubricating composition thereof with: 1) from 200-4000 ppm of magnesium atoms, suitably from 200-2000 ppm, from 300 to 1500 ppm or from 450-1200 ppm of magnesium atoms (ASTM D5185), and 2) at least 500 ppm, preferably at least 750 ppm, more preferably at least 900 ppm of atomic calcium, such as from 500-4000 ppm, preferably from 750-3000 ppm, more preferably from 900-2000 ppm atomic calcium (ASTM D5185).

The detergent may comprise one or more calcium detergents such as calcium carboxylate (e.g., salicylate), sulfonate, or phenate detergent.

Suitably the calcium detergent has a TBN of from 30 to 700 mgKOH/g (ASTM D2896), such as 50 to 650 mgKOH/g, such as 200 to 500 mgKOH/g, such as 240 to 450 mgKOH/g or alternately of 150 mgKOH/g or less, such as 100 mgKOH/g or less, or 200 mgKOH/g or more, or 300 mgKOH/g or more, or 350 mgKOH/g or more.

Suitably, the calcium detergent is a calcium salicylate, sulfonate, or phenate having a TBN of from 30 to 700 mgKOH/g, 30 to 650 mgKOH/g (ASTM D2896), such as 50 to 650 mgKOH/g, such as 200 to 500 mgKOH/g, such as 240 to 450 mgKOH/g or alternately of 150 mgKOH/g or less, such as 100 mgKOH/g or less, or 200 mgKOH/g or more, or 300 mgKOH/g or more, or 350 mgKOH/g or more.

Calcium detergent is typically present in amount sufficient to provide at least 500 ppm, preferably at least 750, more preferably at least 900 ppm atomic calcium to the lubricating oil composition (ASTM D5185). If present, any calcium detergent is suitably present in amount sufficient to provide no more than 4000 ppm, preferably no more than 3000 ppm, more preferably no more than 2000 ppm atomic calcium to the lubricating oil composition (ASTM D5185). If present, any calcium detergent is suitably present in amount sufficient to provide at from 500-4000 ppm, preferably from 750-3000 ppm more preferably from 900-2000 ppm atomic calcium to the lubricating oil composition (ASTM D5185).

Suitably the total atomic amount of metal from detergent in the lubrication composition according to all aspects of the disclosure is no more than 5000 ppm, preferably no more than 4000 μm and more preferably no more than 2000 ppm (ASTM D5185). The total amount of atomic metal from detergent in the lubrication oil composition according to all aspects of the disclosure is suitably at least 500 ppm, preferably at least 800 ppm and more preferably at least 1000 ppm (ASTM D5185). The total amount of atomic metal from detergent in the lubrication oil composition according to all aspects of the disclosure is suitably from 500 to 5000 ppm, preferably from 500 to 3000 ppm and more preferably from 500 to 2000 ppm (ASTM D5185).

Sulfonate detergents may be prepared from sulfonic acids which are typically obtained by the sulfonation of alkyl substituted aromatic hydrocarbons, such as those obtained from the fractionation of petroleum or by the alkylation of aromatic hydrocarbons. Examples include those obtained by alkylating benzene, toluene, xylene, naphthalene, diphenyl, or their halogen derivatives such as chlorobenzene, chlorotoluene, and chloronaphthalene. The alkylation may be carried out in the presence of a catalyst with alkylating agents having from 3 to more than 70 carbon atoms. The alkaryl sulfonates usually contain from 9 to 80 or more carbon atoms, preferably from 16 to 60 carbon atoms per alkyl substituted aromatic moiety. The oil soluble sulfonates or alkaryl sulfonic acids may be neutralized with oxides, hydroxides, alkoxides, carbonates, carboxylate, sulfides, hydrosulfides, nitrates, borates and ethers of the metal. The amount of metal compound is chosen having regard to the desired TBN of the final product, but typically ranges from 100 to 220 mass % (preferably at least 125 mass %) of that stoichiometrically required.

Metal salts of phenols and sulfurized phenols are prepared by reaction with an appropriate metal compound such as an oxide or hydroxide and neutral or overbased products may be obtained by methods well known in the art. Sulfurized phenols may be prepared by reacting a phenol with sulfur or a sulfur-containing compound such as hydrogen sulfide, sulfur monohalide, or sulfur dihalide, to form products which are generally mixtures of compounds in which 2 or more phenols are bridged by sulfur-containing bridges.

Carboxylate detergents, e.g., salicylates, can be prepared by reacting an aromatic carboxylic acid (such as a C₅₋₁₀₀, C₉₋₃₀, C₁₄₋₂₄ alkyl-substituted hydroxy-benzoic acid) with an appropriate metal compound such as an oxide or hydroxide and neutral or overbased products may be obtained by methods well known in the art. The aromatic moiety of the aromatic carboxylic acid can contain heteroatoms, such as nitrogen and oxygen. Preferably, the moiety contains only carbon atoms; more preferably the moiety contains six or more carbon atoms; for example, benzene is a preferred moiety. The aromatic carboxylic acid may contain one or more aromatic moieties, such as one or more benzene rings, either fused or connected via alkylene bridges.

Preferred substituents in oil-soluble salicylic acids are alkyl substituents. In alkyl-substituted salicylic acids, the alkyl groups advantageously contain 5 to 100, preferably 9 to 30, especially 14 to 20, carbon atoms. Where there is more than one alkyl group, the average number of carbon atoms in all of the alkyl groups is preferably at least 9 to ensure adequate oil solubility.

In embodiments, the ratio of atomic detergent metal to atomic molybdenum in the lubricating oil composition may be less than 3:1, such as less than 2:1.

Further, as metal organic and inorganic base salts, which are used as detergents can contribute to the sulfated ash content of a lubricating oil composition, in embodiments of the present disclosure, the amounts of such additives are minimized. In order to maintain a low sulfur level, salicylate detergents can be used, and the lubricating composition herein may comprise one or more salicylate detergents (said detergents are preferably used in amounts in the range of 0.05 to 20.0 mass %, more preferably from 1.0 to 10.0 mass % and most preferably in the range of from 2.0 to 5.0 mass %, based on the total weight of the lubricating composition).

The total sulfated ash content of the lubricating composition herein is typically not greater than 2.0 mass %, alternately at a level of not greater than 1.0 mass % and alternately at a level of not greater than 0.8 mass %, based on the total weight of the lubricating composition as determined by ASTM D874.

Furthermore, it is useful that each of the detergents, independently, have a TBN (total base number) value in the range of from 10 to 700 mgKOH/g, 10 to 500 mgKOH/g, alternately in the range of from 100 to 650, alternately in the range of from 10 to 500 mgKOH/g, alternately in the range of from 30 to 350 mgKOH/g, and alternately in the range of from 50 to 300 mgKOH/g, as measured by ISO 3771.

The sulfonate detergents (such as Ca and/or Mg sulfonate detergents) may be present in an amount to deliver 0.1 mass % to 1.5 mass %, or 0.15 to 1.2 mass %, or 0.2 mass % to 0.9 mass % sulfonate soap to the lubricant composition.

The salicylate detergents (such as Ca and/or Mg salicylate detergents) are present in an amount to deliver 0.3 mass % to 1.4 mass %, or 0.35 mass % to 1.2 mass %, or 0.4 mass % to 1.0 mass % salicylate soap to the lubricant composition.

The sulfonate soap may be present in an amount 0.2 mass % to 0.8 mass % of the lubricant composition, and the salicylate soap may be present in an amount 0.3 mass % to 1.0 mass % of the lubricant composition.

The total of all alkaline earth metal detergent soap may be present in an amount 0.6 mass % to 2.1 mass %, or 0.7 mass % to 1.4 mass % of the lubricant composition.

Typically, lubricating compositions formulated for use in heavy-duty diesel engines comprise detergents at from 0.1 to 10 mass %, alternately from 0.5 to 7.5 mass %, alternately from 1 to 6.5 mass %, based on the lubricating composition.

Typically, lubricating compositions formulated for use in passenger-car engines comprise detergents at from 0.1 to 10 mass %, alternately from 0.5 to 7.5 mass %, alternately from 1 to 6.5 mass %, based on the lubricating composition.

Typically, lubricating compositions formulated for use in a drive train (e.g., transmissions) comprise detergents at from 0.1 to 10 mass %, alternately from 0.5 to 7.5 mass %, alternately from 2 to 6.5 mass %, based on the lubricating composition.

### G. Antioxidants

The LOC and concentrates described herein may include one or more antioxidant compounds, or “antioxidants”. Antioxidants retard the oxidative degradation of base oils during service. Such degradation may result in deposits on metal surfaces, the presence of sludge, a viscosity increase in a lubricant, and the like. A wide variety of oxidation inhibitors that are useful in lubricating oil compositions. See Lubricants and Related Products, Klamann, Wiley VCH, 1984; U.S. Pat. Nos. 4,798,684 and 5,084,197, for example.

Useful antioxidants include hindered phenols. These phenolic antioxidants may be ashless (metal-free) phenolic compounds or neutral or basic metal salts of certain phenolic compounds. Typical phenolic antioxidant compounds are the hindered phenolics, which contain a sterically hindered hydroxyl group, and these include those derivatives of dihydroxy aryl compounds in which the hydroxyl groups are in the o- or p-position to each other. Typical phenolic antioxidants include the hindered phenols substituted with C₆₊ alkyl groups and the alkylene coupled derivatives of these hindered phenols. Examples of phenolic materials of this type 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; and 2-methyl-6-t-butyl-4-dodecyl phenol. Other useful hindered mono-phenolic antioxidants may include, for example, hindered 2,6-di-alkyl-phenolic propionic ester derivatives. Bis-phenolic antioxidants may also be advantageously used herein. Examples of ortho-coupled phenols include: 2,2′-bis(4-heptyl-6-t-butyl-phenol); 2,2′-bis(4-octyl-6-t-butyl-phenol); and 2,2′-bis(4-dodecyl-6-t-butyl-phenol). Para-coupled bisphenols include, for example, 4,4′-bis(2,6-di-t-butyl-phenol) and 4,4′-methylene-bis(2,6-di-t-butyl-phenol).

Effective amounts of one or more catalytic antioxidants may also be used. The catalytic antioxidants comprise an effective amount of a) one or more oil soluble polymetal organic compounds; and effective amounts of b) one or more substituted N,N′-diaryl-o-phenylenediamine compounds or c) one or more hindered phenol compounds; or a combination of both b) and c). Catalytic antioxidants useful herein are more fully described in U.S. Pat. No. 8,048,833.

Non-phenolic oxidation inhibitors, which may be used include aromatic amine antioxidants and these may be used either as such or in combination with phenolics. Typical examples of non-phenolic antioxidants include: alkylated and non-alkylated aromatic amines such as aromatic monoamines of the general formula R³R⁴R⁵N, where R³ is an aliphatic, aromatic or substituted aromatic group, R⁴ is an aromatic or a substituted aromatic group, and R⁵ is H, alkyl, aryl or R⁶S(O)XR⁷ where R⁶ is an alkylene or aryl-alkylene group, R⁷ is an alkyl group, or an alkenyl, aryl, or alkaryl group, and x is 0, 1, or 2. The aliphatic group R³ may contain from 1 to 20 carbon atoms, and preferably contains from 6 to 12 carbon atoms. The aliphatic group is typically a saturated aliphatic group. Preferably, both R³ and R⁴ are aromatic or substituted aromatic groups, and the aromatic group may be a fused ring aromatic group such as naphthyl. Aromatic groups R³ and R⁴ may be joined together with other groups such as S.

Typical aromatic amines antioxidants have alkyl substituent groups of at least 6 carbon atoms. Examples of aliphatic groups include hexyl, heptyl, octyl, nonyl, and decyl. Generally, the aliphatic groups will not contain more than 14 carbon atoms. The general types of amine antioxidants useful in the present compositions include diphenylamines, phenyl naphthylamines, phenothiazines, imidodibenzyls and diphenyl phenylene diamines. Mixtures of two or more aromatic amines are also useful. Polymeric amine antioxidants can also be used. Particular examples of aromatic amine antioxidants useful in the present disclosure include p,p′-dioctyldiphenylamine; t-octylphenyl-alpha-naphthylamine; phenyl-alpha-naphthylamine; and p-octylphenyl-alpha-naphthylamine.

Sulfur-containing antioxidants are also useful herein. In particular, one or more oil-soluble or oil-dispersible sulfur-containing antioxidant(s) can be used as an antioxidant additive. For example, sulfurized alkyl phenols and alkali or alkaline earth metal salts thereof also are useful antioxidants herein. Suitably, the lubricating oil composition(s) of the present disclosure may include the one or more sulfur-containing antioxidant(s) in an amount to provide the lubricating oil composition with from 0.02 to 0.2, preferably from 0.02 to 0.15, even more preferably 0.02 to 0.1, even more preferably 0.04 to 0.1, mass % sulfur based on the total mass of the lubricating oil composition. Optionally the oil-soluble or oil-dispersible sulfur-containing antioxidant(s) are selected from sulfurized C₄ to C₂₅ olefin(s), sulfurized aliphatic (C₇ to C₂₉) hydrocarbyl fatty acid ester(s), ashless sulfurized phenolic antioxidant(s), sulfur-containing organo-molybdenum compound(s), and combinations thereof. For further information on sulfurized materials useful as antioxidants herein, please see U.S. Pat. No. 10,731,101 (col 15, ln 55 to col 22, ln 12).

Antioxidants useful herein include hindered phenols and/or arylamines. These antioxidants may be used individually by type or in combination with one another.

Typical antioxidants include: Irganox™ L67, Irganox™ L135, Ethanox™ 4702, Lanxess Additin™ RC 7110; Ethanox™ 4782J; Irganox™ 1135, Irganox™ 5057, sulfurized lard oil and palm oil fatty acid methyl ester.

Antioxidant additives may be used in an amount of 0.01 to 10 (alternately 0.01 to 5, alternately 0.01 to 3) mass %, alternately 0.03 to 5 mass %, alternately 0.05 to less than 3 mass %, based upon the weight of the lubricating composition.

Compositions according to the present disclosure may contain an additive having a different enumerated function that also has secondary effects as an antioxidant (for example, phosphorus-containing anti-wear agents (such as ZDDP) may also have antioxidant effects). These additives are not included as antioxidants for purposes of determining the amount of antioxidant in a lubricating oil composition or concentrate herein.

### H. Pour Point Depressants

The LOC and concentrates described herein may include one or more components that act as pour point depressants. Conventional pour point depressants (also known as lube oil flow improvers or LOFI's) may be added to the compositions of the present disclosure if desired. These pour point depressants may be added to lubricating compositions of the present disclosure to lower the minimum temperature at which the fluid will flow or can be poured. Examples of suitable pour point depressants include polymethacrylates, polyacrylates, polyarylamides, condensation products of haloparaffin waxes and aromatic compounds, vinyl carboxylate polymers, and terpolymers of dialkylfumarates, vinyl esters of fatty acids and allyl vinyl ethers. U.S. Pat. Nos. 1,815,022; 2,015,748; 2,191,498; 2,387,501; 2,655,479; 2,666,746; 2,721,877; 2,721,878; and 3,250,715 describe useful pour point depressants and/or the preparation thereof. Such additives may be used in an amount of 0.01 to 5 mass %, preferably 0.01 to 1.5 mass %, based upon the weight of the lubricating composition.

### L. Anti-Foam Agents

The LOC and concentrates described herein may include one or more anti-foam agents. These agents prevent or retard the formation of stable foams. Silicones and/organic polymers are typical anti-foam agents. For example, polysiloxanes, such as silicon oil or polydimethyl siloxane, provide anti-foam properties.

Anti-foam agents are commercially available and may be used in minor amounts such as 5 mass % or less, 3 mass % or less, 1 mass % or less, 0.1 mass % or less, such as from 5 to mass % to 0.1 ppm such as from 3 mass % to 0.5 ppm, such as from 1 mass % to 10 ppm.

For example, it may be that the lubricating oil composition comprises an anti-foam agent comprising polyalkyl siloxane, such as a polydialkyl siloxane, for example, wherein the alkyl is a C₁-C₁₀ alkyl group, e.g., a polydimethylsiloxane (PDMS), also known as a silicone oil. It may be that, for example, the lubricating oil composition comprises a polymeric siloxane compound substituted independently by methyl, ethyl, propyl, butyl, pentyl, hexyl, heptyl, octyl, nonyl or decyl, phenyl, naphthyl, alkyl substituted phenyl, or isomers thereof (such as methyl, phenyl), and having a silicon number from 3 to 1000, such as 50 to 450, alternately such as 40 to 100.

Additionally, or alternatively, it may be that the lubricating oil composition comprises an organo-modified siloxane (OMS), such as a siloxane modified with an organo group such as a polyether (e.g., ethylene-propyleneoxide copolymer), long chain hydrocarbyl (e.g., C₁₁-C₁₀₀ alkyl), or aryl (e.g., C₆-C₁₄ aryl). It may be that, for example, the lubricating oil composition comprises an organo-modified siloxane compound wherein the silicon number is from 3 to 2000, such as 50 to 450 (alternately such as 40 to 100), and substituted by the same or different alkyl groups, optionally wherein group is, independently an organo group, such as an organo group selected from polyether (e.g., ethylene-propyleneoxide copolymer), long chain hydrocarbyl (e.g., C₁₁-C₁₀₀ alkyl), or aryl (e.g., C₆-C₁₄ aryl).

Based on the total weight of the lubricant composition, the siloxane according to the formula above is incorporated to provide 0.1 to less than 30 ppm Si, or 0.1 to 25 ppm Si, or 0.1 to 20 ppm Si, or 0.1 to 15 ppm Si, or 0.1 to 10 ppm Si. Preferably, it is in the range of 3-10 ppm Si.

In embodiments, silicone anti-foam agents useful herein are available from Dow Corning Corporation and Union Carbide Corporation, such as Dow Corning FS-1265 (1000 centistokes), Dow Corning DC-200, and Union Carbide UC-L45. Silicone anti-foamants useful herein include polydimethylsiloxane, phenyl-methyl polysiloxane, linear, cyclic or branched siloxanes, silicone polymers and copolymers, and/organo-silicone copolymers. Also, a siloxane polyether copolymer Anti-foamant is available from OSI Specialties, Inc. of Farmington Hills, Michigan and may be substituted or included. One such material is sold as SILWET-L-7220. Additional useful silicon containing agents include those disclosed in EP 3 366 755 A1.

Acrylate polymer anti-foam agent can also be used herein. Typical acrylate anti-foamants include polyacrylate anti-foamant available from Monsanto Polymer Products Co. known as PC-1244. A preferred acrylate polymer anti-foam agent useful herein is PX™3841 (i.e., an alkyl acrylate polymer), commercially available from Dorf Ketl, also referred to as Mobilad™C402.

### J. Viscosity Modifiers

The LOC and concentrates described herein may include one or more viscosity modifiers. Viscosity modifiers provide lubricants with high and low temperature operability. These additives impart shear stability at elevated temperatures and acceptable viscosity at low temperatures. Suitable viscosity modifiers include high molecular weight hydrocarbons, polyesters, and viscosity modifier dispersants (also referred to as a dispersant viscosity modifiers or DVM's) that can function as both a viscosity modifier and a dispersant. Typical molecular weights of these polymers are between 10,000 to 1,500,000 g/mol, more typically 20,000 to 1,200,000 g/mol, and even more typically between 50,000 and 1,000,000 g/mol.

Examples of suitable viscosity modifiers are linear or radial (star-shaped) polymers and copolymers of methacrylate, butadiene, olefins, or alkylated styrenes. Polyisobutylene is a commonly used viscosity modifier. Another suitable viscosity modifier is polymethacrylate (copolymers of various chain length alkyl methacrylates, for example), some formulations of which also serve as pour point depressants. Other suitable viscosity modifiers include copolymers of ethylene and propylene, hydrogenated block copolymers of styrene and isoprene, and polyacrylates (copolymers of various chain length acrylates, for example). Specific examples include styrene-isoprene or styrene-butadiene based polymers of 50,000 to 200,000 g/mol molecular weight.

Copolymers useful as viscosity modifiers include those commercially available from Chevron Oronite Company LLC under the trade designation Paratone™ (such as Paratone™ 8921, Paratone™ 68231, and Paratone™ 8941); from Afton Chemical Corporation under the trade designation HiTEC™ (such as HiTEC™ 5850B, and HiTEC™5777); and from The Lubrizol Corporation under the trade designation Lubrizol™ 7067C. Hydrogenated polyisoprene radial (star) polymers useful as viscosity modifiers herein include those commercially available from Infineum International Limited, e.g., under the trade designation SV200™ and SV600™. Hydrogenated diene-styrene block copolymers useful as viscosity modifiers herein are commercially available from Infineum International Limited, e.g., under the trade designation SV150™.

Polymers useful as viscosity modifiers herein include polymethacrylate or polyacrylate polymers, such as linear polymethacrylate or polyacrylate polymers, such as those available from Evnoik Industries under the trade designation Viscoplex™ (e.g., Viscoplex™ 6-954) or star polymers which are available from Lubrizol Corporation under the trade designation Asteric™ (e.g., Lubrizol™ 87708 and Lubrizol™ 87725).

Vinyl aromatic-containing polymers useful as viscosity modifiers herein may be derived from vinyl aromatic hydrocarbon monomers, such as styrenic monomers, such as styrene. Illustrative vinyl aromatic-containing copolymers useful herein may be represented by the following general formula: A-B wherein A is a polymeric block derived predominantly from vinyl aromatic hydrocarbon monomer (such as styrene), and B is a polymeric block derived predominantly from conjugated diene monomer (such as isoprene).

Vinyl aromatic-containing polymers useful as viscosity modifiers may have a Kinematic viscosity at 100° C. of 20 cSt or less, such as 15 cSt or less, such as 12 cSt or less, but may be diluted (such as in Group I, II, and/or III base oil) to higher Kinematic viscosities at 100° C., such as to 40 cSt or more, such as 100 cSt or more, such as 1000 cSt or more, such as 1000 to 2000 cSt).

Dispersant viscosity modifiers useful herein include the amide, imide, and/or ester functionalized partially or fully saturated polymer comprising C₄₋₅ olefins as described in US 2024-0141156 A1, which is herein incorporated by reference in its entirety. These DVM's (also referred to as “functionalized polymer(s)”) are a functionalized hydrogenated polyisoprene family of polymers for use in lubricating oil compositions.

Other useful DVM's include functionalized olefin copolymers (such as amine functionalized ethylene propylene copolymers).

Vinyl aromatic-containing polymer concentrates prepared in base oil (such as in Group I, II, and/or III base oil) useful as viscosity modifiers may have a Kinematic viscosity at 100° C. of 40 cSt or more, such as 100 cSt or more, such as 1000 cSt or more, such as 1000 to 2000 cSt. Further dilution in base oil (such as in Group I, II, and/or III base oil) may lower the viscosities at 100° C., such as to 20 cSt or less, such as 15 cSt or less, such as 12 cSt or less.

Typically, the viscosity modifiers may be used in an amount of 0.01 to 10 mass %, such as 0.1 to 7 mass %, such as 0.1 to 4 mass %, such as 0.2 to 2 mass %, such as 0.2 to 1 mass %, and such as 0.2 to 0.5 mass %, based on the total weight of the formulated lubricant composition.

Viscosity modifiers are typically added as concentrates, in large amounts of diluent oil. The “as delivered” viscosity modifier typically contains from 20 mass % to 75 mass % of an active polymer for polymethacrylate or polyacrylate polymers, or from 8 mass % to 20 mass % of an active polymer for olefin copolymers, hydrogenated polyisoprene star polymers, or hydrogenated diene-styrene block copolymers, in the “as delivered” polymer concentrate.

### K. Dispersants

The LOC and concentrates described herein may include one or more compounds or compositions that act as dispersants. In any embodiment, at least one dispersant of the LOC is one or more capped polyamines as described herein. During engine operation, oil-insoluble oxidation byproducts are produced. Dispersants help keep these byproducts in solution, thus diminishing their deposition on metal surfaces. Dispersants used in the formulation of the lubricating compositions herein may be ashless or ash-forming in nature. Preferably, the dispersant is ashless. So called ashless dispersants are organic materials that form substantially no ash upon combustion. For example, non-metal-containing or borated metal-free dispersants are considered ashless. In contrast, metal-containing detergents tend to form ash upon combustion.

Dispersants useful herein typically contain a polar group attached to a relatively high molecular weight hydrocarbon chain. The polar group typically contains at least one element of nitrogen, oxygen, or phosphorus. Typical hydrocarbon chains contain 40 to 500, such as 50 to 400 carbon atoms. When used in context of functionalized polymers operating as dispersants, the molecular weights are typically reported in terms of the base polymer prior to modification. For example, PIBSA-PAM dispersant molecular weights are typically reported for the base polymer prior to functionalization with the acylating agent (maleic acid or anhydride) and functional group (such as polyamine). Hence, herein dispersant molecular weights are assigned the molecular weight of the base polymer the dispersant is derived from.

A particularly useful class of dispersants includes the (poly)alkenylsuccinic derivatives, typically produced by the reaction of a long chain hydrocarbyl-substituted succinic compound, usually a hydrocarbyl-substituted succinic anhydride, with a polyhydroxy or polyamino compound. The long chain hydrocarbyl group constituting the oleophilic portion of the molecule which confers solubility in the oil, is often a polyisobutylene group (typically the long chain hydrocarbyl group, such as a polyisobutylene group, has an Mn of 400 to 3000 g/mol, such as 450 to 2500 g/mol). Many examples of this type of dispersant are well known commercially and in the literature. Exemplary US patents describing such dispersants include U.S. Pat. Nos. 3,172,892; 3,2145,707; 3,219,666; 3,316,177; 3,341,542; 3,444,170; 3,454,607; 3,541,012; 3,630,904; 3,632,511; 3,787,374 and 4,234,435. Other types of dispersants are described in U.S. Pat. Nos. 3,036,003; 3,200,107; 3,254,025; 3,275,554; 3,438,757; 3,454,555; 3,565,804; 3,413,347; 3,697,574; 3,725,277; 3,725,480; 3,726,882; 4,454,059; 3,329,658; 3,449,250; 3,519,565; 3,666,730; 3,687,849; 3,702,300; 4,100,082; 5,705,458. A further description of dispersants useful herein may be found, for example, in EP 0 471 071 A1 and EP 0 451 380 A1, to which reference is made for this purpose.

Hydrocarbyl-substituted succinic acid and hydrocarbyl-substituted succinic anhydride derivatives are useful dispersants. In particular, succinimide, succinate esters, or succinate ester amides prepared by the reaction of a hydrocarbon-substituted succinic acid or anhydride compound (typically having at least 25 carbon atoms, such as 28 to 400 carbon atoms, in the hydrocarbon substituent), with at least one equivalent of a polyhydroxy or polyamino compound (such as an alkylene amine) are particularly useful herein. Hydrocarbyl-substituted succinic acid and hydrocarbyl-substituted succinic anhydride derivatives may have a number average molecular weight of at least 400 g/mol, such as at least 900 g/mol, such as at least 1500 g/mol, such as from 400 to 4000 g/mol, such as from 800 to 3000, such as from 2000 to 2800 g/mol, such from 2100 to 2500 g/mol, and such as from 2200 to 2400 g/mol.

Succinimides, which are particularly useful herein, are formed by the condensation reaction between: 1) hydrocarbyl-substituted succinic anhydrides, such as polyisobutylene succinic anhydride (PIBSA); and 2) polyamine (PAM). Examples of suitable polyamines include: polyhydrocarbyl polyamines, polyalkylene polyamines, hydroxy-substituted polyamines, polyoxyalkylene polyamines, and combinations thereof. Examples of polyamines include tetraethylene pentamine, pentaethylene hexamine, tetraethylenepentamine (TEPA), pentaethylenehaxamine (PEHA), N-phenyl-p-phenylenediamine (ADPA), and other polyamines having an average of 5, 6, 7, 8, or 9 nitrogen atoms per molecule. Mixtures where the average number of nitrogen atoms per polyamine molecule is greater than 7 are commonly called heavy polyamines or H-PAMs and may be commercially available under trade names such as HPA™ and HPA-X™ from Dow Chemical, E-100™ from Huntsman Chemical. Examples of hydroxy-substituted polyamines include N-hydroxyalkyl-alkylene polyamines such as N-(2-hydroxyethyl)ethylene diamine, N-(2-hydroxyethyl)piperazine, and/or N-hydroxyalkylated alkylene diamines of the type described, for example, in U.S. Pat. No. 4,873,009. Examples of polyoxyalkylene polyamines include polyoxyethylene and/or polyoxypropylene diamines and triamines (as well as co-oligomers thereof)having an average Mn from 200 to 5000 g/mol. Products of this type are commercially available under the tradename Jeffamine™. Representative examples of useful succinimides are shown in U.S. Pat. Nos. 3,087,936; 3,172,892; 3,219,666; 3,272,746; 3,322,670; 3,652,616; 3,948,800; and 6,821,307; and CA Patent No. 1,094,044.

The dispersants may comprise one or more, optionally borated, higher molecular weight (Mn 1600 g/mol or more, such as 1800 to 3000 g/mol) succinimides and one or more, optionally borated, lower molecular weight (Mn less than 1600 g/mol) succinimides, where the higher molecular weight may be 1600 to 3000 g/mol, such as 1700 to 2800 g/mol, such as 1800 to 2500 g/mol, such as 1850 to 2300 g/mol; and the lower molecular weight may be 600 to less than 1600 g/mol, such as 650 to 1500 g/mol, such as 700 to 1400 g/mol, such as 800 to 1300 g/mol, such as 850 to 1200 g/mol such as 900 to 1150 g/mol, such as 900 to 1000 g/mol. The higher molecular weight succinimide dispersant may be present in the lubricating composition in an amount of from 0.5 to 10 mass %, or from 0.8 to 6 mass %, or from 1.0 to 5 mass %, or from 1.5 to 5 mass %, or from 1.5 to 4.0 mass %; and the lower molecular weight succinimides dispersant may be present in the lubricating composition in an amount of from 1 to 5 mass %, or from 1.5 to 4.8 mass %, or from 1.8 to 4.6 mass %, or from 1.9 to 4.6 mass %, or at 2 mass % or more, such as 2 to 5 mass %. The lower molecular weight succinimides may differ from the higher molecular weight succinimides, by 500 g/mol or more, such as by 750 g/mol or more, such as by 1000 g/mol or more, such as by 1200 g/mol or more, such as by 500 to 3000 g/mol, such as by 750 to 2000 g/mol, such as by 1000 to 1500 g/mol.

Succinate esters useful as dispersants include those formed by the condensation reaction between hydrocarbyl-substituted succinic anhydrides and alcohols or polyols. For example, the condensation product of hydrocarbyl-substituted succinic anhydride and pentaerythritol is a useful dispersant.

Succinate ester amides useful herein are formed by a condensation reaction between hydrocarbyl-substituted succinic anhydrides and alkanol amines. Suitable alkanol amines include ethoxylated polyalkylpolyamines, propoxylated polyalkylpolyamines, and polyalkenylpolyamines such as polyethylene polyamines and/or propoxylated hexamethylenediamine. Representative examples are shown in U.S. Pat. No. 4,426,305.

Hydrocarbyl-substituted succinic anhydrides (such as PIBSA) esters of hydrocarbyl bridged aryloxy alcohols are also useful as dispersants herein. For information on such dispersants, please see U.S. Pat. No. 7,485,603, particularly, col 2, ln 65 to col 6, ln 22 and col 23, ln 40 to col 26, ln 46. In particular, PIBSA esters of methylene-bridged naphthyloxy ethanol (i.e., 2-hydroxyethyl-1-naphthol ether (or hydroxy-terminated ethylene oxide oligomer ether of naphthol) are useful herein.

The molecular weight of the hydrocarbyl-substituted succinic anhydrides used in the preceding paragraphs will typically range from 350 to 4000 g/mol, such as 400 to 3000 g/mol, such as 450 to 2800 g/mol, such as 800 to 2500 g/mol. The above (poly)alkenylsuccinic derivatives can be post-reacted with various reagents such as sulfur, oxygen, formaldehyde, carboxylic acids such as oleic acid.

The dispersants may be present in the lubricant in an amount 0.1 mass % to 20 mass % of the composition, such as 0.2 to 15 mass %, such as 0.25 to 10 mass %, such as 0.3 to 5 mass %, such as 1.0 mass % to 3.0 mass %, of the lubricating oil composition.

The above (poly)alkenylsuccinic derivatives, can also be post reacted with boron compounds such as boric acid, borate esters or highly borated dispersants, to form borated dispersants generally having from 0.1 to 5 moles of boron per mole of dispersant reaction product.

Dispersants useful herein include borated succinimides, including those derivatives from mono-succinimides, bis-succinimides, and/or mixtures of mono- and bis-succinimides, wherein the hydrocarbyl succinimide is derived from a hydrocarbylene group such as polyisobutylene having an Mn of from 300 to 5000 g/mol, or from 500 to 3000 g/mol, or 1000 to 2000 g/mol, or a mixture of such hydrocarbylene groups, often with high terminal vinylic groups.

The boron-containing dispersant may be present at 0.01 mass % to 20 mass %, or 0.1 mass % to 15 mass %, or 0.1 mass % to 10 mass %, or 0.5 mass % to 8 mass %, or 1.0 mass % to 6.5 mass %, or 0.5 mass % to 2.2 mass % of the lubricating composition.

The boron-containing dispersant may be present in an amount to deliver boron to the composition at 15 ppm to 2000 ppm, or 25 ppm to 1000 ppm, or 40 ppm to 600 ppm, or 80 ppm to 350 ppm.

The borated dispersant may be used in combination with non-borated dispersant and may be the same or different compound as the non-borated dispersant. In one embodiment, the lubricating composition may include one or more boron-containing dispersants and one or more non-borated dispersants, wherein the total amount of dispersant may be 0.01 mass % to 20 mass %, or 0.1 mass % to 15 mass %, or 0.1 mass % to 10 mass %, or 0.5 mass % to 8 mass %, or 1.0 mass % to 6.5 mass %, or 0.5 mass % to 2.2 mass % of the lubricating composition and wherein the ratio of borated dispersant to non-borated dispersant may be 1:10 to 10:1 (weight:weight) or 1:5 to 3:1 or 1:3 to 2:1.

The dispersant may comprise one or more borated or non-borated poly(alkenyl)succinimides, where the polyalkyenyl is derived from polyisobutylene and the imide is derived from a polyamine (“PIBSA-PAM”).

The dispersant may comprise one or more PIBSA-PAMs, where the PIB is derived from polyisobutylene having an Mn of from 600 to 5000, such as from 700 to 4000, such as from 800 to 3000, such as from 900 to 2500 g/mol and the polyamine is derived from hydrocarbyl-substituted polyamines, such as tetraethylene pentamine, pentaethylene hexamine, tetraethylenepentamine (TEPA), pentaethylenehaxamine (PEHA), N-phenyl-p-phenylenediamine (ADPA), and other polyamines having an average of 5, 6, 7, 8, or 9 nitrogen atoms per molecule). The dispersant may be borated, typically at levels of up to 4 mass % such as from 1 to 3 mass %. The dispersant may comprise one or more borated and one or more non-borated PIBSA-PAM's. The dispersant may comprise one or more borated PIBSA-PAM's derived from a PIB having an Mn of 700 to 1800 g/mol (such as 800 to 1500 g/mol) and one or more non-borated PIBSA-PAM's derived from a PIB having an Mn of more than 1800 to 5000 g/mol (such as 2000 to 3000 g/mol). The dispersant may comprise one or more non-borated PIBSA-PAM's derived from a PIB having an Mn of 700 to 1800 g/mol (such as 800 to 1500 g/mol) and one or more borated PIBSA-PAM's derived from a PIB having an Mn of more than 1800 to 5000 g/mol (such as 2000 to 3000 g/mol).

The dispersant may comprise PIBSA derived from a PIB having an Mn of 700 to 5000 g/mol (such as 800 to 3000 g/mol) and one or more borated or non-borated PIBSA-PAM's derived from a PIB having an Mn of 700 to 5000 g/mol.

The dispersant may comprise PIBSA derived from a PIB having an Mn of 700 to 5000 g/mol (such as 800 to 3000 g/mol) and one or more borated PIBSA-PAM's derived from a PIB having an Mn of 700 to 1800 g/mol (such as 800 to 1500 g/mol) and one or more non-borated PIBSA-PAM's derived from a PIB having an Mn of more than 1800 to 5000 g/mol (such as 2000 to 3000 g/mol). The dispersant may comprise PIBSA derived from a PIB having an Mn of 700 to 5000 g/mol (such as 800 to 3000 g/mol) one or more non-borated PIBSA-PAM's derived from a PIB having an Mn of 700 to 1800 g/mol (such as 800 to 1500 g/mol) and one or more borated PIBSA-PAM's derived from a PIB having an Mn of more than 1800 to 5000 g/mol (such as 2000 to 3000 g/mol).

The dispersant may comprise one or more borated or non-borated PIBSA-PAM's and one or more PIBSA-esters of hydrocarbyl bridged aryloxy alcohols.

The dispersant may comprise one or more borated and one or more non-borated PIBSA-PAM's.

The dispersant may comprise one or more, optionally borated, higher molecular weight (Mn 1600 g/mol or more, such as 1800 to 3000 g/mol) PIBSA-PAM's and one or more, optionally borated, lower molecular weight (Mn less than 1600 g/mol) PIBSA-PAM's, where the higher molecular weight may be 1600 to 3000 g/mol, such as 1700 to 2800 g/mol, such as 1800 to 2500 g/mol, such as 1850 to 2300 g/mol; and the lower molecular weight may be 600 to less than 1600 g/mol, such as 650 to 1500 g/mol, such as 700 to 1400 g/mol, such as 800 to 1300 g/mol, such as 850 to 1200 g/mol, such as 900 to 11500 g/mol, such as 900 to 100 g/mol. The higher molecular weight PIBSA-PAM dispersant may be present in the lubricating composition in an amount of from 0.5 to 10 mass %, or from 0.8 to 6 mass %, or from 1.0 to 5 mass %, or from 1.5 to 5 mass % or from 1.5 to 4.0 mass %; and the lower molecular weight PIBSA-PAM dispersant may be present in the lubricating composition in an amount of from 1 to 5 mass %, or from 1.5 to 4.8 mass %, or from 1.8 to 4.6 mass %, or from 1.9 to 4.6 mass %, or at 2 mass % or more, such as 2 to 5 mass %.

Mannich base dispersants useful herein are typically made from the reaction of an amine component, a hydroxy aromatic compound (substituted or unsubstituted, such as alkyl substituted), such as alkylphenols, and an aldehyde, such as formaldehyde. See U.S. Pat. Nos. 4,767,551 and 10,899,986. Process aids and catalysts, such as oleic acid and sulfonic acids, can also be part of the reaction mixture. Representative examples are shown in U.S. Pat. Nos. 3,697,574; 3,703,536; 3,704,308; 3,751,365; 3,756,953; 3,798,165; 3,803,039; 4,231,759; 9,938,479; 7,491,248; and 10,899,986, and PCT Publication No. WO 01/42399.

Polymethacrylate or polyacrylate derivatives are another class of dispersants useful herein. These dispersants are typically prepared by reacting a nitrogen-containing monomer and a methacrylic or acrylic acid esters containing 5-25 carbon atoms in the ester group. Representative examples are shown in U.S. Pat. Nos. 2,100,993, and 6,323,164. Polymethacrylate and polyacrylate dispersants are typically lower molecular weights.

The dispersant may comprise (or consist of, or consist essentially of) one or more capped polyamines such as the capped version of any of the polyamines described herein typically used as dispersants. Such capped polyamines will have the same or similar property as described for other polyamine-type dispersants.

The lubricating composition of the disclosure typically comprises dispersant at 0.1 mass % to 20 mass % of the composition, such as 0.2 to 15 mass %, such as 0.25 to 10 mass %, such as 0.3 to 5 mass %, such as 2.0 mass % to 4.0 mass % of the lubricating oil composition. Alternately the dispersant may be present at 0.1 mass % to 5 mass %, or 0.01 mass % to 4 mass % of the lubricating composition.

Compositions according to the present disclosure may contain an additive having a different enumerated function that also has secondary effects as a dispersant (for example, Component B Functionalized Polymer described above, may also have dispersant effects). These additives are not included as dispersants for purposes of determining the amount of dispersant in a lubricating oil composition or concentrate herein.

### L. Corrosion Inhibitors/Anti-Rust Agents

The LOC and concentrates described herein may include one or more corrosion inhibitors and/or anti-rust agents. Suitable corrosion inhibitors may include nitrogen and/or sulfur-containing heterocyclic compounds such as other versions of: triazoles, thiadiazoles, imidazoles, thiazoles, tetrazoles, hydroxyquinolines, oxazolines, imidazolines, thiophenes, indoles, indazoles, quinolines, benzoxazines, dithiols, oxazoles, oxatriazoles, pyridines, piperazines, triazines and derivatives of any one or more thereof.

Additionally, or alternatively, the corrosion inhibitor may include one or more thiadiazoles, such as 2,5-substituted thiadiazoles independently substituted by hydrogen or a hydrocarbon group, which group may be aliphatic or aromatic, including cyclic, alicyclic, aralkyl, aryl and alkaryl, and wherein each w is independently 1, 2, 3, 4, 5, or 6 (preferably 2, 3, or 4, such as 2). These substituted thiadiazoles are derived from the 2,5-dimercapto-1,3,4-thiadiazole (DMTD) molecule. Many derivatives of DMTD have been described in the art, and any such compounds may be included in the fluid used in the present disclosure. For example, U.S. Pat. Nos. 2,719,125; 2,719,126; and 3,087,937; describe the preparation of various 2, 5-bis-(hydrocarbon dithio)-1,3,4-thiadiazoles.

Further, additionally or alternatively, the corrosion inhibitor may include one or more other derivatives of DMTD, such as a carboxylic ester in which R₁₅ and R₁₆ may be joined to the sulfide sulfur atom through a carbonyl group. Preparation of these thioester containing DMTD derivatives is described, for example, in U.S. Pat. No. 2,760,933. DMTD derivatives produced by condensation of DMTD with alpha-halogenated aliphatic carboxylic acids having at least 10 carbon atoms are described, for example, in U.S. Pat. No. 2,836,564. This process produces DMTD derivatives substituted by a HOOC—CH(R)— group, R being a hydrocarbyl group. DMTD derivatives further produced by amidation or esterification of these terminal carboxylic acid groups may also be useful.

The preparation of 2-hydrocarbyldithio-5-mercapto-1,3,4-thiadiazoles is described, for example, in U.S. Pat. No. 3,663,561.

A class of DMTD derivatives may include mixtures of a 2-hydrocarbyldithio-5-mercapto-1,3,4-thiadiazole and a 2,5-bis-hydrocarbyldithio-1,3,4-thiadiazole. Such mixtures may be sold under the tradename HiTEC™ 4313 and are commercially available from Afton Chemical Company.

The preparation of 2-hydrocarbyldithio-5-mercapto-1,3,4-thiadiazoles is described, for example, in U.S. Pat. No. 3,663,561.

Still further, additionally or alternatively, the corrosion inhibitor may include a trifunctional borate having the structure, B(OR)₃, in which each R₄₆ may be the same or different. As the borate may typically be desirably compatible with the non-aqueous medium of the composition, each R may comprise or be a hydrocarbyl C₁-C₈ moiety. For compositions in which the non-aqueous medium comprises or is one or more base oils, for example, better compatibility can typically be achieved when the hydrocarbyl moieties are each at least C₄. Non-limiting examples of such corrosion inhibitors thus include, but are not limited to, triethylborate, tripropylborates such as triisopropylborate, tributylborates such as tri-tert-butylborate, tripentylborates, trihexylborates, trioctylborates such as tri-(2-ethylhexyl)borate, monohexyl dibutylborate, and the like, as well as combinations thereof.

When used, a corrosion inhibitor may comprise a substituted thiadiazole, a substituted triazole, a trisubstituted borate, or a combination thereof.

When desired, the additional corrosion inhibitors can be used in any effective amount; and in any embodiment present within a range from 0.001 mass % to 5.0 mass %, based on the weight of the composition, e.g., from 0.005 mass % to 3.0 mass % or from 0.01 mass % to 1.0 mass %. Alternately, such additives may be used in an amount of 0.01 to 5 mass %, preferably 0.01 to 1.5 mass %, based upon the weight of the lubricating composition.

### M. Anti-Wear Agents

The LOC and concentrates described herein may include one or more anti-wear agents that can reduce friction and excessive wear. Any anti-wear agent known by a person of ordinary skill in the art may be used in the lubricating oil composition. Non-limiting examples of suitable anti-wear agents include zinc dithiophosphate, metal (e.g., Pb, Sb, Mo, and the like) salts of dithiophosphates, metal (e.g., Zn, Pb, Sb, Mo, and the like) salts of dithiocarbamates, metal (e.g., Zn, Pb, Sb, and the like) salts of fatty acids, boron compounds, phosphate esters, phosphite esters, amine salts of phosphoric acid esters or thiophosphoric acid esters, reaction products of dicyclopentadiene and thiophosphoric acids and combinations thereof. Preferably, the “metal” is a Group 6 to Group 15 metal, especially having an atomic number of at least 20, or 30, such as Zn, Mo, Pb, and Sb. The amount of the anti-wear agent may vary from 0.01 mass % to 5 mass %, from 0.05 mass % to 3 mass %, or from 0.1 mass % to 1 mass %, based on the total weight of the lubricating oil composition.

In embodiments, the anti-wear agent is or comprises a dihydrocarbyl dithiophosphate metal salt, such as zinc dialkyl dithiophosphate compounds. The metal of the dihydrocarbyl dithiophosphate metal salt may be an alkali or alkaline earth metal, or aluminum, lead, tin, molybdenum, manganese, nickel, or copper. In some embodiments, the metal is zinc. In other embodiments, the dihydrocarbyl dithiophosphate metal salt is substituted by C₃ to C₁₂, or Cis, or C₂₂ linear or branched alkyl groups.

Useful anti-wear agents also include substituted or unsubstituted thiophosphoric acids, and salts thereof include zinc-containing compounds such as zinc dithiophosphate compounds selected from zinc dialkyl-, diaryl- and/or alkylaryl-dithiophosphates.

A metal alkylthiophosphate and more particularly a metal dialkyl dithio phosphate in which the metal constituent is zinc, or zinc dialkyl dithio phosphate (ZDDP) can be a useful component of the lubricating compositions of this disclosure. ZDDP can be derived from primary alcohols, secondary alcohols or mixtures thereof. ZDDP compounds generally are of the formula Zn[SP(S)(OR)(OR)]₂ wherein the R groups are the same or different C₁-C₁₈ alkyl groups, preferably C₂-C₁₂ alkyl groups. These alkyl groups may be straight chain or branched. Alcohols used in the ZDDP can be 2-propanol, butanol, secondary butanol, pentanols, hexanols such as 4-methyl-2-pentanol, n-hexanol, n-octanol, 2-ethyl hexanol, alkylated phenols, and the like. Mixtures of secondary alcohols or of primary and secondary alcohol can be used. Alkyl aryl groups may also be used. Useful zinc dithiophosphates include secondary zinc dithiophosphates such as those available from The Lubrizol Corporation under the trade designations LZ™ 677A, LZ™ 1095 and LZ™ 1371, from Chevron Oronite under the trade designation OLOA™ 262 and from Afton Chemical under the trade designation HiTEC™ 7169.

In any embodiment, the zinc compound can be a zinc dithiocarbamate complex, such as the zinc dithiocarbamates substituted independently by a linear, cyclic, or branched, saturated or unsaturated, aliphatic C₁ to C₁₀ hydrocarbon moiety, and comprising from 1 to 3 ligands selected from the group consisting of water, hydroxide, ammonia, amino, amido, alkylthiolate, halide, and combinations thereof.

The anti-wear additives, such as ZDDP and/or the zinc carbamates, are typically used in amounts of from 0.4 mass % to 1.2 mass %, preferably from 0.5 mass % to 1.0 mass %, and more preferably from 0.6 mass % to 0.8 mass %, based on the total weight of the lubricating composition, although more or less can often be used advantageously. Preferably, the anti-wear additive is ZDDP, preferably a secondary ZDDP, and is present in an amount of from 0.6 to 1.0 mass % of the total weight of the lubricating composition.

Anti-wear additives useful herein also include boron-containing compounds, such as borate esters, borated fatty amines, borated epoxides, alkali metal (or mixed alkali metal or alkaline earth metal) borates and borated overbased metal salts.

### N. Demulsifiers

The LOC and concentrates described herein may include one or more compounds or compositions that act as demulsifiers. Demulsifiers useful herein include those described in U.S. Pat. No. 10,829,712 (col 20, ln 34-40). Typically, a small amount of a demulsifying component may be used herein. A preferred demulsifying component is described in European Patent No. 330 522. It is obtained by reacting an alkylene oxide with an adduct obtained by reacting a bis-epoxide with a polyhydric alcohol. Such additives may be used in an amount of 0.001 to 5 mass %, preferably 0.01 to 2 mass %.

### O. Seal Compatibility Agents

Other optional additives include seal compatibility agents such as organic phosphates, aromatic esters, aromatic hydrocarbons, esters (butylbenzyl phthalate, for example), and polybutenyl succinic anhydride. Such additives may be used in an amount of 0.001 to 5 mass %, preferably 0.01 to 2 mass %. In embodiments the seal compatibility agents are sea swell agents, such as PIBSA (polyisobutenyl succinic anhydride).

### P. Extreme Pressure Agents

The lubricating oil composition of the present disclosure can contain one or more extreme pressure agents that can prevent sliding metal surfaces from seizing under conditions of extreme pressure. Any extreme pressure agent known by a person of ordinary skill in the art may be used in the lubricating oil composition. Generally, the extreme pressure agent is a compound that can combine chemically with a metal to form a surface film that prevents the welding of asperities in opposing metal surfaces under high loads. Non-limiting examples of suitable extreme pressure agents include sulfurized animal or vegetable fats or oils, sulfurized animal or vegetable fatty acid esters, fully or partially esterified esters of trivalent or pentavalent acids of phosphorus, sulfurized olefins, dihydrocarbyl polysulfides, sulfurized Diels-Alder adducts, sulfurized dicyclopentadiene, sulfurized or co-sulfurized mixtures of fatty acid esters and monounsaturated olefins, co-sulfurized blends of fatty acid, fatty acid ester and alpha-olefin, functionally substituted dihydrocarbyl polysulfides, thia-aldehydes, thia-ketones, epithio-compounds, sulfur-containing acetal derivatives, co-sulfurized blends of terpene and acyclic olefins, and poly sulfide olefin products, amine salts of phosphoric acid esters or thiophosphoric acid esters, and combinations thereof. The amount of the extreme pressure agent may vary from 0.01 mass % to 5 mass %, from 0.05 mass % to 3 mass %, or from 0.1 mass % to 1 mass %, based on the total weight of the lubricating oil composition.

### Q. LOC, Concentrate and Methods of Using the LOC

Also disclosed is a lubricating oil composition comprising 60 to 95 mass % of one or more base oils, and 5 to 40 mass % of one or more additives, wherein the at least one of the additives comprises a capped polyamine. Such capped polyamines may act as a dispersant in the LOC, and the LOC may comprise two or more types of capped polyamines, additional non-capped polyamines, and mixtures thereof. The LOC may also comprise other classes of dispersants such as those discussed herein.

The capped polyamine dispersant may be present in the lubricant in an amount 0.1 mass % to 20 mass % of the composition, such as 0.2 to 15 mass %, such as 0.25 to 10 mass %, such as 0.3 to 5 mass %, such as 1.0 mass % to 3.0 mass %, of the lubricating oil composition.

Also disclosed herein is a lubricating oil concentrate, a “concentrate” of components that can be, or is capable, of being diluted to be used an LOC as described herein. In any embodiment, the concentrate comprises (or consists of, or consists essentially of) 5 to 50 mass % of one or more base oils, and 50 to 95 mass % of two, three or more additives, based on the total weight of the concentrate.

In any embodiment, the concentrate further comprises 0.1 to 20 mass % of an anti-wear agent.

In any embodiment, the concentrate further comprises 0.1 to 40 mass % of a detergent.

In any embodiment, the concentrate further comprises 0.1 to 40 mass % of a dispersant.

In any embodiment, the concentrate further comprises 0.1 to 40 mass % of an antioxidant.

In any embodiment, one or more base oils are admixed with the concentrate to form a lubricating oil composition comprising 60 to 95 mass % of one or more base oils, and 5 to 40 mass % of two, three or more additives, wherein the LOC can be described as in any embodiment herein.

When lubricating oil compositions contain one or more of the additives discussed above, the additive(s) are typically blended into the composition in an amount sufficient for it to perform its intended function. It is noted that many of the additives are shipped from the additive manufacturer as a concentrate, containing one or more additives together, with a certain amount of base oil or other diluents. Accordingly, the weight amounts mentioned herein, are directed to the amount of active ingredient (that is the non-diluent portion of the ingredient). The weight percent (mass %) indicated below is based on the total weight of the lubricating oil composition.

The foregoing additives are typically commercially available materials. These additives may be added independently, but are usually pre-combined in packages, which can be obtained from suppliers of lubricant oil additives. Additive packages with a variety of ingredients, proportions and characteristics are available and selection of the appropriate package will take the use of the ultimate composition into account.

This disclosure also relates to a method of lubricating an automotive internal combustion engine during operation of the engine comprising:
(i) providing to a crankcase of the automotive internal combustion engine an automotive crankcase the LOC (or concentrate diluted and blended to form the LOC) described herein;
(ii) providing a hydrocarbon fuel in the automotive internal combustion engine; and
(iii) combusting the fuel in the automotive internal combustion engine, such as a spark-ignited or compression-ignited two- or four-stroke reciprocating engines such as a diesel engine or passenger car engine (such as a spark-ignited combustion engine).

This disclosure also relates to a fuel composition comprising the lubricating oil compositions described herein and a hydrocarbon fuel, wherein the fuel may be derived from petroleum and/or biological sources (“biofuel” or “renewable fuel”). In embodiments, the fuel comprises from 0.1 to 100 mass % renewable fuel, alternately from 1 to 75 mass % renewable fuel, alternately from 5 to 50 mass % renewable fuel, based upon the total mass of the from 1 to 50 mass % renewable fuel and the petroleum derived fuel.

The renewable fuel component is typically produced from vegetable oil (such as palm oil, rapeseed oil, soybean oil, jatropha oil), microbial oil (such as algae oil), animal fats (such as cooking oil, animal fat, and/or fish fat), biogas, hydrogen or ammonia. Renewable fuel refers to hydrogen, ammonia and biofuel produced from biological resources formed through contemporary biological processes. In an embodiment, the renewable fuel component is produced by means of a hydrotreatment process. Hydrotreatment involves various reactions where molecular hydrogen reacts with other components, or the components undergo molecular conversions in the presence of molecular hydrogen and a solid catalyst. The reactions include, but are not limited to, hydrogenation, hydrodeoxygenation, hydrodesulfurization, hydrodenitrification, hydrodemetallization, hydrocracking, and isomerization. The renewable fuel component may have different distillation ranges, which provide the desired properties to the component, depending on the intended use.

This invention also relates to a method of lubricating an internal combustion engine during operation of the engine comprising: (i) providing to an internal combustion engine, such as to a crankcase, the LOC (or concentrate diluted and blended to form the LOC) as described herein; (ii) providing fuel comprising hydrogen and or ammonia to the internal combustion engine; and (iii) combusting the fuel in an internal combustion engine, such as a hydrogen or ammonia fueled engine.

The lubricating compositions of the disclosure may be used to lubricate mechanical engine components, particularly in internal combustion engines, e.g., spark-ignited or compression-ignited, two- or four-stroke reciprocating engines, by adding the lubricant thereto. Typically, they are crankcase lubricants, such as passenger car motor oils or heavy-duty diesel engine lubricants.

In particular, the lubricating compositions of the present disclosure are suitably used in the lubrication of the crankcase of a compression-ignited, internal combustion engine, such as a heavy-duty diesel engine.

In particular, the lubricating compositions of the present disclosure are suitably used in the lubrication of the crankcase of a spark-ignited turbo charged internal combustion engine.

In embodiments, the lubricating oils of this disclosure are used in spark-assisted high compression internal combustion engines and, when used in high compression spark ignition internal combustion engines the lubricating oil compositions of this disclosure are useful in lubricating high compression spark ignition engines.

In embodiments, the lubricating compositions of the present disclosure are suitably used in the lubrication of the crankcase of an engine for a heavy-duty diesel vehicle (i.e., a heavy-duty diesel vehicle having a gross vehicle weight rating of 10,000 pounds or more.)

In embodiments, the lubricating compositions of the present disclosure are suitably used in the lubrication of the crankcase of a passenger car diesel engine.

In particular, lubricating oil formulations of this disclosure are particularly useful in compression-ignited internal combustion engines, i.e., heavy-duty diesel engines, employing low viscosity oils, such as API FA-4 and future oil categories, in which wear protection of the valve train becomes challenging.

The lubricating compositions of the invention may be useful as marine lubricants, such as trunk piston engine oils (TPEOs), MDCLs (marine diesel cylinder lubricants), system oils, and such.

Also, the lubricating compositions of the invention may be useful as lubricants for natural gas engines [e.g., natural gas is the fuel the engines run on, commonly called GEOs or (natural) gas engine oils].

Also, the lubricating compositions of the invention may be useful as lubricants for hydrogen engines, ammonia engines and the like [e.g., hydrogen (or hydrogen combined with natural gas) and or ammonia is the fuel the engines run on].

The lubricating compositions of the invention may be used to lubricate mechanical engine components, particularly in internal combustion engines, e.g., spark-ignited or compression-ignited two- or four-stroke reciprocating engines, by adding the lubricant thereto. Typically, they are crankcase lubricants, such as passenger car motor oils or heavy-duty diesel engine lubricants.

In particular, the lubricating compositions of the present invention are suitably used in the lubrication of the crankcase of a compression-ignited internal combustion engine, such as a heavy-duty diesel engine. The lubricating compositions described herein are particularly suitable for internal combustion engines that are prone to piston-liner wear from a long duration of operation, hence the invention might extend engine lifetime.

In particular, the lubricating compositions of the present invention are suitably used in the lubrication of the crankcase of a spark-ignited turbo charged internal combustion engine.

The lubricating oils of this disclosure are particularly useful in high compression spark ignition internal combustion engines.

The lubricating oils described herein are also useful for lubricating a hydrogen or ammonia fueled internal combustion engine during operation of the engine comprising: (i) providing to an internal combustion engine, such as to a crankcase, the LOC (or concentrate diluted and blended to form the LOC) as described herein; (ii) providing fuel comprising hydrogen and or ammonia to the internal combustion engine; and (iii) combusting the fuel in an internal combustion engine, such as a hydrogen or ammonia fueled engine.

Also, the lubricating compositions of the invention may be useful as lubricants for hydrogen engines, ammonia engines and the like [e.g., hydrogen (or hydrogen combined with natural gas) and or ammonia (or ammonia combined with hydrocarbon fuel, such as gasoline or diesel fuel) is the fuel the engines use].

The lubricating oils described herein are also useful for lubricating a hydrogen or ammonia fueled internal combustion engine during operation of the engine comprising: (i) providing to an internal combustion engine, such as to a crankcase, the LOC (or concentrate diluted and blended to form the LOC) as described herein; (ii) providing fuel comprising hydrogen and or ammonia to the internal combustion engine; and (iii) combusting the fuel in an internal combustion engine, such as a hydrogen or ammonia fueled engine.

### R. Additional Numbered Embodiments/Clauses of the Invention

Having described the methods of capping polyamines, polyamines therefrom, lubricating oil concentrates and compositions in their various potential embodiments, described herein as numbered embodiments or clauses is:
1. A capped polyamine comprising a polyamine having capping groups on at least 0.8 equivalents, based on the equivalents of amines in the polyamine, and less than 0.01 equivalents of carbon dioxide, based on the equivalents of capping agent used, released upon formation of the capped polyamine.
2. The capped polyamine of clause 1, wherein less than 0.001 equivalents of carbon dioxide is released.
3. The capped polyamine of clauses 1-2, wherein the polyamine is a polyisobutylene-polyamine block copolymer.
4. The capped polyamine of clauses 1-3, wherein the capping group is selected from the group consisting of the reaction products of the polyamine with organic anhydrides having the structure O═C(—O—R)₂, organic carbonates having the structure (RC(O))₂O, and combinations thereof, wherein each R groups is independently selected from C₁ to C₁₀ alkyls, C₆ to C₁₂ aryls, and wherein two R groups may form a fused saturated or unsaturated ring.
5. The capped polyamine of clauses 1-4, wherein the capping group is selected from the group consisting of the reaction product of the polyamine with organic carbonates, organic anhydrides, and combinations thereof.
6. The capped polyamine of clause 5, wherein the organic carbonates are selected from the group consisting of ethylene carbonate, propylene carbonate, butylene carbonate, dimethyl carbonate, derivatives thereof, and combinations thereof.
7. The capped polyamine of clauses 5-6, wherein the organic anhydrides are selected from the group consisting of acetic anhydride, propionic anhydride, maleic anhydride, phthalic anhydride, benzoic anhydride, derivatives thereof, and combinations thereof.
8. The capped polyamine of clauses 1-7, wherein the capping groups comprise carbamate groups.
9. A lubricant additive package comprising at least one capped polyamine of clauses 1-8.
10. A lubricant oil composition comprising at least one capped polyamine of clauses 1-9.
11. A capped polyamine comprising a polyamine having carbamate capping groups on at least 0.8 equivalents, based on the equivalents of amines in the polyamine.
12. The capped polyamine of clause 11, wherein less than 0.01 equivalents of carbon dioxide is released, based on the equivalents of capping agent used.
13. The capped polyamine of clauses 11-12, wherein the polyamine is a polyisobutylene-polyamine block copolymer.
14. The capped polyamine of clauses 11-13, wherein the capping group is selected from the group consisting of the reaction products of the polyamine with organic anhydrides having the structure O═C(—O—R)₂, organic carbonates having the structure (RC(O))₂O, and combinations thereof, wherein each R groups is independently selected from C₁ to C₁₀ alkyls, C₆ to C₁₂ aryls, and wherein two R groups may form a fused saturated or unsaturated ring.
15. The capped polyamine of clauses 11-14, wherein the capping group is selected from the group consisting of the reaction product of the polyamine with organic carbonates, organic anhydrides, and combinations thereof.
16. The capped polyamine of clause 15, wherein the organic carbonates are selected from the group consisting of ethylene carbonate, propylene carbonate, butylene carbonate, dimethyl carbonate, derivatives thereof, and combinations thereof.
17. The capped polyamine of clause 15-16, wherein the organic anhydrides are selected from the group consisting of acetic anhydride, propionic anhydride, maleic anhydride, phthalic anhydride, benzoic anhydride, derivatives thereof, and combinations thereof.
18. The capped polyamine of clauses 11-17, wherein the capping groups comprise carbamate groups.
19. A lubricant additive package comprising at least one capped polyamine of clauses 11-18.
20. A lubricant oil composition comprising at least one capped polyamine of clauses 11-19.
21. A method of capping one or more amine groups within a polymer comprising: providing a polyamine, combining a capping agent with the polyamine at a temperature of less than or equal to 130° C., and recovering capped polyamine, wherein less than 0.01 equivalents of carbon dioxide, based on the equivalents of capping agent used, is released from the reaction.
22. The method of clause 21, wherein less than 0.001 equivalents of carbon dioxide is released from the reaction.
23. The method of clauses 21-22, wherein the combining step takes place for at least 12 hours.
24. The method of clauses 21-23, wherein the combining step is at a temperature within a range from 70° C. to 130° C.
25. The method of clauses 21-24, wherein the combining step takes place in a non-polar solvent or no solvent.
26. The method of clauses 21-25, wherein the polyamine is a polyisobutylene-polyamine block copolymer.
27. The method of clauses 21-26, wherein the capping agent is selected from the group consisting of organic anhydrides having the structure O═C(—O—R)₂, organic carbonates having the structure (RC(O))₂O, and combinations thereof, wherein each R groups is independently selected from C₁ to C₁₀ alkyls, or C₆ to C₁₂ aryls, and wherein two R groups may form a fused saturated or unsaturated ring.
28. The method of clauses 21-27, wherein the capping agent is selected from the group consisting of organic carbonates, organic anhydrides, and combinations thereof.
29. The method of clause 28, wherein the organic carbonates are selected from the group consisting of ethylene carbonate, propylene carbonate, butylene carbonate, dimethyl carbonate, derivatives thereof, and combinations thereof.
30. The method of clauses 28-29, wherein the organic anhydrides are selected from the group consisting of acetic anhydride, propionic anhydride, maleic anhydride, phthalic anhydride, benzoic anhydride, derivatives thereof, and combinations thereof.
31. The method of clauses 21-30, wherein the capped polyamine comprises carbamate groups.

The following non-limiting examples are provided to illustrate the disclosure.

### Examples

Determining Carbon Dioxide. The combining of capping agent(s) with polyamine(s) can take place in a vessel of any desirable size, preferably comprising a gas inlet and outlet such that gasses such as nitrogen can be purged through the reactor and the outlet can allow nitrogen or, additionally, CO₂ that has evolved from the reaction to pass out of the reaction vessel. The amount of CO₂ released from combining the capping agent with the polyamine in the inventive method was determined by either of two methods. In the first method, CO₂ was measured from the flow rate of gas out from the reactor, while nitrogen passing through the reactor was at a set flow rate, any increase in this flow rate detected in the exhaust was assumed to be CO₂. In the second method, exhaust gases from the reactor were bubbled through two or more scrubbers containing aqueous sodium hydroxide solutions, capturing any CO₂ which was then quantified by weighing the solutions before and after the reaction. Both methods were able to demonstrate that the CO₂ released in the low temperature process was below that of the high temperature method, and usually below the detectable limit of either method, meaning no measurable CO₂ was released.

Inventive Capped Polyamine Synthesis—Low Temperature Process. Polyamine (dispersant) and base oil were charged into a baffled glass reactor equipped with a nitrogen inlet, overhead stirrer, and air condenser. In all the experiments described herein, the polyamine was a low viscosity (α, ω)-succinimide functionalized polyamine. The mixture was heated to 80° C. Molten ethylene carbonate was then charged as a single addition at 80° C. That reaction mixture was held at 80° C. for 48 hours, in the final hour vacuum was applied, about 40 mbar. After 48 hours, the vacuum was released and the product decanted, where capped polyamine was isolated.

Comparative Capped Polyamine Synthesis—High Temperature Process. Polyamine and base oil were charged into a baffled glass reactor equipped with a nitrogen inlet, overhead stirrer and air condenser. The mixture was heated to between 8° and 120° C. Molten ethylene carbonate was charged as either a single shot or over a maximum of 2 hours. The reaction mixture was heated to 160° C. for over 2 hours. Then temperature was held at 160° C. for an additional 3 hours, in the final hour vacuum was applied, about 40 mbar. The vacuum was released, and the product cooled to between 100° C. and 120° C. before decanting, where capped polyamine was isolated.

Capped-Low Viscosity Polyamine Carbon-13 NMR Fingerprinting. To characterize a standard capped polyamine, a homogenous sample of capped polyamine in CDCl₃—600 mg/600 mL was prepared. A carbon-13 NMR experiment at 10240 scans (approx. 11 hours) was conducted. All spectra and assignments were captured using a Bruker Avance III 300 MHz Spectrometer. A singlet at about 14.0 ppm to 14.2 ppm to 14.1 ppm was aligned. The area between 14.28 ppm to 13.90 ppm was integrated and set integral reference to 10. Then all peak areas were then integrated as summarized in Table 1, where the integrals were plotted against typical values obtained as summarized in Table 2 to assess for compositional differences. Note that carbon-13 NMR integrations are qualitative and show batch to batch variation, the method was not quantitative. Full structural assignments were assigned and shown graphically in FIG. 1 and described and summarized in Table 1. Low and high temperature capping experimental results are summarized in Table 3 on the basis of this standard.

TABLE 1
Carbon-13 NMR homogenous sample
of Capped Polyamine in CDCl₃

| Carbon Peak | Integral Area | |
|---|---|---|
| (ppm) | (ppm) | Assignment |
| 46.9 | 46.60-47.25 | Uncapped Amine |
| 48.5-49.5 | 48.25-49.75 | Uncapped Amine |
| 60.7 | 60.30-61.05 | 2-hydroxyethyl carbamate |
| 67.5 | 67.00-68.00 | 2-hydroxyethyl carbamate |
| 64.4 | Peak overlaps-no | 2-(2-hydroxyethoxy) ethyl carbamate |
| | integral | (Overlap with EC) |
| 69.5 | 68.95-69.75 | 2-(2-hydroxyethoxy) ethyl carbamate |
| 70.4 | 69.75-70.75 | 2-(2-aminoethoxy) ethan-1-ol |
| 61.3 | 61.05-61.70 | Ethoxyethanol |
| 72.7 | 72.10-73.25 | Ethoxyethanol |
| 156.5 (Broad) | 155.25-157.25 | All Carbamates |
| 61.9 | 61.75-62.05 | 2-(((2-hydroxyethoxy) carbonyl) oxy) |
| | | ethyl carbamate (tentative) |
| 66.9 | 66.70-67.00 | 2-aminoethyl (2-hydroxyethyl) |
| | | carbamate (tentative) |

TABLE 2
Typical Carbon-13 NMR Values for a Capped Polyamine

| | SUF Values, high | Control Experiment, |
|---|---|---|
| Carbon Peak (ppm) | temperature | high temperature |
| 46.9 (46.6-47.25) | 2.05 | 2.07 |
| 48.5-49.5 (48.25-49.75) | 2.80 | 2.85 |
| 60.7 (60.3-61.05) | 1.32 | 1.27 |
| 67.5 (67-68) | 0.85 | 0.81 |
| 69.5 (68.95-69.75) | 1.43 | 1.47 |
| 70.4 (69.75-70.75) | 3.18 | 2.71 |
| 61.3 (61.05-61.7) | 3.68 | 3.00 |
| 72.7 (72.1-73.25) | 3.31 | 2.49 |
| 156.5 (155.25-157.25) | 1.45 | 1.5 |
| 61.9 (61.75-62.05) | 0.14 | 0.18 |
| 66.9 (66.7-67.0) | 0.09 | 0.13 |

TABLE 3
Carbon-13 NMR Peaks of Capped Polyamine
at Different Conditions

| | Low Temperature | High Temperature |
|---|---|---|
| | Process | Process |
| | 1.5 equiv. | 1.5 equiv. |
| | ethylene carbonate, | ethylene carbonate, |
| Carbon Peaks (ppm) | 80° C., 48 hrs. | 80° C., 48 hrs. |
| Amine Peak A | 2.00 | 2.07 |
| (46.6-47.25) | | |
| Amine Peak B | 2.77 | 2.85 |
| (48.25-49.75) | | |
| 2-hydroxyethyl carbamate | 1.99 | 1.27 |
| Peak 1 | | |
| (60.3-61.05) | | |
| 2-hydroxyethyl carbamate | 1.55 | 0.81 |
| Peak 2 | | |
| (67.0-68.0) | | |
| 2-(2-hydroxyethoxy) ethyl | 0.17 | 1.47 |
| carbamate | | |
| (68.95-69.75) | | |
| 2-(2-aminoethoxy) ethan-1-ol | −0.06 | 2.71 |
| (69.75-70.75) | | |
| Ethoxyethanol Peak 1 | 0.42 | 3.00 |
| (61.05-61.7) | | |
| Ethoxyethanol Peak 2 | 0.34 | 2.49 |
| (72.1-73.25) | | |
| All Carbamates | 1.55 | 1.50 |
| (155.25-157.25) | | |
| 2-(((2-hydroxyethoxy) | 0.03 | 0.18 |
| carbonyl) oxy) ethyl | | |
| carbamate | | |
| (61.75-62.05) | | |
| 2-aminoethyl | 0.15 | 0.15 |
| (2-hydroxyethyl) carbamate | | |
| (66.7-67.0) | | |

The “fingerprint” of the carbon-13 NMR integrals for the low and high temperature products yielded by the two different processes demonstrates the distinct change in capping group distribution. The NMR data for comparative high temperature examples in Table 2 between Scale Up Facility (SUF) preparations (right) and a single control experiment done under conditions otherwise similar to the inventive examples at low temperature. The SUF values are the average carbon-13 NMR values from about 8 large batches synthesised using the high temperature process. All these experiments returned very similar and repeatable values and a mean average is shown in the Table 2. The data in Table 3 evidence a marked difference between low and high temperature fingerprints for the capped polyamines. An advantage of the lower temperature method giving controlled carbamate/carbonate chemoselectivity is reduced carbon dioxide emissions as this moiety is retained in the product. An additional advantage of the low temperature method is the lower energy usage.

All documents described herein are incorporated by reference herein, including any priority documents and/or testing procedures, to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. The term “comprising” is considered synonymous with the term “including.” Likewise, whenever a composition, an element, or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

What is claimed is:

1. A capped polyamine comprising a polyamine having capping groups on at least 0.8 equivalents, based on the equivalents of amines in the polyamine, and less than 0.01 equivalents of carbon dioxide, based on the equivalents of capping agent used, released upon formation of the capped polyamine.

2. The capped polyamine of claim 1, wherein less than 0.001 equivalents of carbon dioxide is released.

3. The capped polyamine of claim 1, wherein the polyamine is a polyisobutylene-polyamine block copolymer.

4. The capped polyamine of claim 1, wherein the capping group is selected from the group consisting of the reaction products of the polyamine with organic anhydrides having the structure O═C(—O—R)₂, organic carbonates having the structure (RC(O))₂O, and combinations thereof, wherein each R groups is independently selected from C₁ to C₁₀ alkyls, C₆ to C₁₂ aryls, and wherein two R groups may form a fused saturated or unsaturated ring.

5. The capped polyamine of claim 1, wherein the capping group is selected from the group consisting of the reaction product of the polyamine with organic carbonates, organic anhydrides, and combinations thereof.

6. The capped polyamine of claim 5, wherein the organic carbonates are selected from the group consisting of ethylene carbonate, propylene carbonate, butylene carbonate, dimethyl carbonate, derivatives thereof, and combinations thereof.

7. The capped polyamine of claim 5, wherein the organic anhydrides are selected from the group consisting of acetic anhydride, propionic anhydride, maleic anhydride, phthalic anhydride, benzoic anhydride, derivatives thereof, and combinations thereof.

8. The capped polyamine of claim 1, wherein the capping groups comprise carbamate groups.

9. A lubricant additive package comprising at least one capped polyamine of claim 1.

10. A lubricant oil composition comprising at least one capped polyamine of claim 1.

11. A capped polyamine comprising a polyamine having carbamate capping groups on at least 0.8 equivalents, based on the equivalents of amines in the polyamine.

12. The capped polyamine of claim 11, wherein less than 0.01 equivalents of carbon dioxide is released, based on the equivalents of capping agent used.

13. The capped polyamine of claim 11, wherein the polyamine is a polyisobutylene-polyamine block copolymer.

14. The capped polyamine of claim 11, wherein the capping group is selected from the group consisting of the reaction products of the polyamine with organic anhydrides having the structure O═C(—O—R)₂, organic carbonates having the structure (RC(O))₂O, and combinations thereof, wherein each R groups is independently selected from C₁ to C₁₀ alkyls, C₆ to C₁₂ aryls, and wherein two R groups may form a fused saturated or unsaturated ring.

15. The capped polyamine of claim 11, wherein the capping group is selected from the group consisting of the reaction product of the polyamine with organic carbonates, organic anhydrides, and combinations thereof.

16. The capped polyamine of claim 15, wherein the organic carbonates are selected from the group consisting of ethylene carbonate, propylene carbonate, butylene carbonate, dimethyl carbonate, derivatives thereof, and combinations thereof.

17. The capped polyamine of claim 15, wherein the organic anhydrides are selected from the group consisting of acetic anhydride, propionic anhydride, maleic anhydride, phthalic anhydride, benzoic anhydride, derivatives thereof, and combinations thereof.

18. The capped polyamine of claim 11, wherein the capping groups comprise carbamate groups.

19. A lubricant additive package comprising at least one capped polyamine of claim 11.

20. A lubricant oil composition comprising at least one capped polyamine of claim 11.

21. A method of capping one or more amine groups within a polymer comprising: providing a polyamine, combining a capping agent with the polyamine at a temperature of less than or equal to 130° C., and recovering capped polyamine, wherein less than 0.01 equivalents of carbon dioxide, based on the equivalents of capping agent used, is released from the reaction.

22. The method of claim 21, wherein less than 0.001 equivalents of carbon dioxide is released from the reaction.

23. The method of claim 21, wherein the combining step takes place for at least 12 hours.

24. The method of claim 21, wherein the combining step is at a temperature within a range from 70° C. to 130° C.

25. The method of claim 21, wherein the combining step takes place in a non-polar solvent or no solvent.

26. The method of claim 21, wherein the polyamine is a polyisobutylene-polyamine block copolymer.

27. The method of claim 21, wherein the capping group is selected from the group consisting of the reaction products of the polyamine with organic anhydrides having the structure O═C(—O—R)₂, organic carbonates having the structure (RC(O))₂O, and combinations thereof, wherein each R groups is independently selected from C₁ to C₁₀ alkyls, C₆ to C₁₂ aryls, and wherein two R groups may form a fused saturated or unsaturated ring.

28. The method of claim 21, wherein the capping agent is selected from the group consisting of organic carbonates, organic anhydrides, and combinations thereof.

29. The method of claim 28, wherein the organic carbonates are selected from the group consisting of ethylene carbonate, propylene carbonate, butylene carbonate, dimethyl carbonate, derivatives thereof, and combinations thereof.

30. The method of claim 28, wherein the organic anhydrides are selected from the group consisting of acetic anhydride, propionic anhydride, maleic anhydride, phthalic anhydride, benzoic anhydride, derivatives thereof, and combinations thereof.

31. The method of claim 21, wherein the capped polyamine comprises carbamate groups.
